(19) United States
(12) Patent Application Publication
(10) Pub. No.: US 2022/0396495 A1
(43) Pub. Date: Dec. 15, 2022

(54) MATERIALS WITH HIGH LIDAR REFLECTIVITY

(71) Applicant: Toyota Motor Engineering & Manufacturing North America, Inc., Plano, TX (US)

(72) Inventors: Songtao Wu, Ann Arbor, MI (US); Debasish Banerjee, Ann Arbor, MI (US); Krishna Gunugunuri, Canton, MI (US)

(73) Assignee: Toyota Motor Engineering & Manufacturing North America, Inc., Plano, TX (US)

(21) Appl. No.: 17/835,338

(22) Filed: Jun. 8, 2022

Related U.S. Application Data
(60) Provisional application No. 63/208,783, filed on Jun. 9, 2021.

(51) Int. Cl. C01G 3/02; C09D 7/61; C09D 5/33

(52) U.S. Cl. CPC C01G 3/02; C09D 7/61; C09D 5/004; C01P 2004/64; C01P 2006/60; C01P 2004/04; C01P 2004/03; C01P 2002/72; C08K 2003/2248

(57) ABSTRACT

A copper oxide crystallite having an average particle size that is greater than or equal to 5 nm and less than or equal to 15 nm, a ratio of (−111)/(111) greater than or equal to 0.5 and less than or equal to 1.5, and a blackness My greater than or equal to 130 and less than or equal to 170. The copper oxide crystallite has a reflectivity in the visible spectrum of electromagnetic radiation that is less than or equal to 10.0%, and a reflectivity in the near-IR and LiDAR spectrum of electromagnetic radiation that is greater than or equal to 10%.

### CROSS-REFERENCE TO RELATED APPLICATION

This application claims the benefit of priority under 35 U.S.C. § 119 of U.S. Provisional Application Ser. No. 63/208,783 filed on Jun. 9, 2021, the content of which is relied upon and incorporated herein by reference in its entirety.

### TECHNICAL FIELD

The present specification generally relates to particles that reflect near-IR electromagnetic radiation and, more specifically, to copper oxide particles that reflect near-IR electromagnetic radiation.

### BACKGROUND

Light detecting and ranging (LiDAR) systems using pulsed laser electromagnetic radiation with a wavelength of 905 nanometers (nm) or 1050 nm have been proposed and tested for autonomous vehicle obstacle detection and avoidance systems as well as in other automated detection systems. However, dark colored (e.g., black) pigments used in paints and other materials to provide a dark-colored objects absorb not only visible electromagnetic radiation to provide the dark color, but also absorb near-IR electromagnetic radiation with wavelengths of greater than about 750 nanometers, which includes LiDAR electromagnetic radiation.

Accordingly, a need exists for alternative dark colored pigments that absorb electromagnetic radiation within the visible spectrum, but that reflect near-IR electromagnetic radiation with wavelengths around 905 nm or 1050 nm.

### SUMMARY

A first aspect includes a copper oxide crystallite comprising: an average particle size that is greater than or equal to 5 nm and less than or equal to 15 nm; a ratio of (−111)/(111) greater than or equal to 0.5 and less than or equal to 1.5; and a blackness My greater than or equal to 130 and less than or equal to 170, wherein the copper oxide crystallite has: a reflectivity in the visible spectrum of electromagnetic radiation that is less than or equal to 10.0%, and a reflectivity in the near-IR and LiDAR spectrum of electromagnetic radiation that is greater than or equal to 10.0%.

A second aspect includes the copper oxide crystallite of the first aspect, wherein the copper oxide crystallite has a reflectivity of electromagnetic radiation in the visible spectrum that is less than or equal to 5.0%.

A third aspect includes the copper oxide crystallite of any one of the first and second aspects, wherein the copper oxide crystallite has a reflectivity for electromagnetic radiation in the near-IR and LiDAR spectrum that is greater than or equal to 20.0%.

A fourth aspect includes the copper oxide crystallite of any one of the first to third aspects, wherein the ratio of (−111)/(111) is greater than or equal to 0.9 and less than or equal to 1.1.

A fifth aspect includes the copper oxide crystallite of any one of the first to fourth aspects, wherein the average particle size is greater than or equal to 8 nm and less than or equal to 12 nm.

A sixth aspect includes the copper oxide crystallite of any one of the first to fifth aspects, wherein the My blackness is greater than or equal to 150 and less than or equal to 170.

A seventh aspect includes the copper oxide crystallite of any one of the first to sixth aspects, wherein the average particle size is greater than or equal to 8 nm and less than or equal to 12 nm, the ratio of (−111)/(111) is greater than or equal to 0.9 and less than or equal to 1.1, the blackness My is greater than or equal to 150 and less than or equal to 170, the reflectivity in the visible spectrum of electromagnetic radiation is less than or equal to 5.0%, and the reflectivity in the near-IR and LiDAR spectrum of electromagnetic radiation is greater than or equal to 20.0%.

An eighth aspect includes a paint comprising: a paint binder; a plurality of copper oxide crystallites according to any one of the first to seventh aspects, wherein the paint has a color with a lightness in CIELAB color space less than or equal to 40.

A ninth aspect includes a vehicle comprising a body panel coated in the paint of the eighth aspect.

A tenth aspect includes a method for forming a copper oxide crystallites comprising: combining a precipitating agent with a solution comprising copper nitrate to form a precipitate; drying the filtered precipitate, thereby obtaining dried precipitate; and sintering the dried precipitate to form copper oxide crystallites having an average particle size that is greater than or equal to 5 nm and less than or equal to 15 nm, wherein the precipitating agent is selected from the group consisting of sodium hydroxide, sodium carbonate, or ammonium carbonate.

An eleventh aspect includes the method of the tenth aspect, wherein the precipitating agent is selected from the group consisting of sodium hydroxide and sodium carbonate.

A twelfth aspect includes the method of the eleventh aspect, wherein a Cu/Na molar ratio is greater than or equal to 0.3 and less than 1.6.

A thirteenth aspect includes the method of the eleventh or twelfth aspects, wherein a Cu/Na molar ratio is greater than or equal to 0.5 and less than 1.0.

A fourteenth aspect includes the method of any of the eleventh to thirteenth aspects, wherein a Cu/Na molar ratio is greater than or equal to 0.65 and less than 0.76.

A fifteenth aspect includes the method of any of the tenth to fourteenth aspects, wherein drying the copper oxide crystallites comprises drying at a temperature greater than or equal to 100° C. and less than or equal to 140° C. for a duration greater than or equal to 0.5 hours and less than or equal to 5.0 hours.

A sixteenth aspect includes the method of any of the tenth to fifteenth aspects, wherein sintering the copper oxide crystallites comprises sintering at a temperature that is greater than or equal to 200° C. and less than or equal to 300° C.

A seventeenth aspect includes the method of any of the tenth to sixteenth aspects, wherein sintering the copper oxide crystallites comprises sintering at a temperature that is greater than or equal to 250° C. and less than or equal to 300° C.

An eighteenth aspect includes the method of any of the tenth to seventeenth aspects, wherein sintering occurs for a duration that is greater than or equal to 0.5 hours and less than or equal to 5.0 hours.

A nineteenth aspect includes the method of any of the tenth to eighteenth aspects, wherein the precipitating agent is ammonium carbonate.

A twentieth aspect includes the method of any of the tenth to nineteenth aspects, wherein the average particle size is greater than or equal to 8 nm and less than or equal to 12 nm.

These and additional features provided by the embodiments described herein will be more fully understood in view of the following detailed description in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A graphically depicts the reflectivity versus wavelength of electromagnetic radiation for conventional colorants;

FIG. 1B graphically depicts the reflectivity versus wavelength of electromagnetic radiation for colorants according to embodiments disclosed and described herein;

FIG. 2 is a bar graph depicting the blackness of commercially available materials and black TiO₂;

FIG. 3A depicts the blackness My value of paints incorporated with carbon black, commercial “cool black”, commercial N-CuO-C and N-CuO-A pigment, respectively, and the insert photo reveals the blackness difference of these four samples;

FIG. 3B graphically depicts the reflectivity of carbon black, commercial “cool black”, commercial N-CuO-C and N-CuO-A pigment, versus wavelength;

FIG. 3C depicts XRD profiles of N-CuO-A, N-CuO-B and commercial N-CuO-C, where planes of (−111) and (111) are major planes for analysis as they have highest peak intensity;

FIG. 3D depicts an evaluation map of samples using the following 2 indicators: crystallite size of (−111) and relative intensity ratio of (−111)/(111), and the insert shows raw particle samples, from left to right, N-CuO-A, N-CuO-B and commercial N-CuO-C, respectively;

FIG. 3E depicts high resolution transmission electron microscope image of N-CuO-A (scale bar—5 nm), the bottom right insert is the zoom-out figure of N-CuO-A sample (scale bar—2 μm). TEM figure demonstrates crystalline lattice features in N-CuO-A sample, and the top insert is selective area electron diffraction (SAED) pattern recorded from an area containing a large number of nanoparticles of N-CuO-A;

FIG. 3F depicts high resolution transmission electron microscope image of N-CuO-B (scale bar—5 nm), the bottom right insert is the zoom-out figure of N-CuO-B sample (scale bar—1 μm), and the top insert is selective area electron diffraction (SAED) pattern recorded from an area containing a large number of nanowires of N-CuO-B;

FIG. 3G depicts XRD spectra of obtained precipitates from different precipitate agents, in comparison to references of pure CuCO₃, CuCO₃.Cu(OH)₂ and Cu(OH)₂;

FIG. 4A depicts the evolution of weight percent and derivative of weight percent curves during the pyrolysis process via TGA, the inserts are the images of the corresponding CuO samples sintered at different temperatures, from left to right, 50° C., 200° C., 300° C. and 500° C.;

FIG. 4B depicts the evolution of average crystallite size of (−111) and relative intensity of (−111)/(111) during pyrolysis via TGA from ambient temperature to 600° C.;

FIG. 5A is a photo taken by a normal camera that reveals the blackness in visible range between carbon black (right) and CuO particles under different sintering temperatures 300° C., 400° C. and 500° C., in comparison to commercial N-CuO-C (left) on a black panel background;

FIG. 5B is SEM images of CuO sintered at 300° C., 400° C. and 500° C. under two different magnifications (all the scale bars in the images are 1 μm);

FIG. 6 is X-ray diffraction profiles of CuO samples before the calcination with varying Cu/Na molar ratios during the synthesis.

FIG. 7 is SEM images of CuO samples after the calcination with varying Cu/Na molar ratios during the synthesis;

FIG. 8 is Cu2p and Na1s XPS profiles of the extracted precipitates with varying Cu/Na molar ratios during the synthesis;

FIG. 9A are Photos of CuO particles with different Cu/Na molar ratios over black background and white background under normal camera (top) and NIR camera (bottom);

FIG. 9B is a photo of painted panels of CuO particles;

FIG. 9C depicts diffuse reflectance of painted panels of CuO particles;

FIG. 9D depicts Tau plots of painted panels of CuO particles;

FIG. 9E depicts indirect bandgap energy values obtained from Tau plots;

FIG. 9F depicts degree of blackness of painted panels of CuO particles with varying Cu/Na molar ratios;

FIG. 10 schematically depicts a vehicle with side panels painted with a LiDAR reflecting dark colored paint according to one or more embodiments disclosed and described herein;

FIG. 11 schematically depicts a cross sectional view of a side panel painted with the LiDAR reflecting dark colored paint;

FIG. 12A graphically depicts the impact of weight ratio of pigment to polymer resin on the degree of blackness over pre-coated black and white backgrounds at wet film thickness of 8 mil (200 μm);

FIG. 12B graphically depicts the impact of wet film thickness on the degree of blackness over precoated black and white backgrounds at weigh ratio of pigment to resin equal to 1:4 (0.25);

FIG. 13A is a photograph of a demonstration set-up using robot car equipped with 2D laser scanner at 905 nm, mimicking an autonomous driving car;

FIG. 13B depicts a comparison of LiDAR intensity obtained by robot car at 8° from painted panels incorporated with carbon black, N-CuO-A, N-CuO-B, commercial N-CuO-C and cool black pigments, respectively;

FIG. 13C is a photograph of a demonstration of robot car hitting carbon black based painted panel with threshold of LiDAR intensity set as 100; and

FIG. 13D is a photograph of a demonstration of robot car stopping in front of painted panel incorporated with N-CuO-A pigment with threshold of LiDAR intensity set as 100.

### DETAILED DESCRIPTION

Copper oxide crystallites disclosed and described herein display a dark color and reflect near-IR electromagnetic radiation, which includes LiDAR, with wavelengths greater than or equal to 850 nm and less than or equal to 1550 nm. In embodiments, the copper oxide crystallites disclosed and described herein can be included in a paint system to form a near-IR and LiDAR-reflecting dark colored paint that can be applied to objects—such as, for example, portions of a vehicle, portions of structures, robots, and the like—so that near-IR and LiDAR detection systems can detect an article coated with the near-IR and LiDAR reflecting dark colored paint.

As used herein, the term “near-IR electromagnetic radiation” refers to electromagnetic radiation with wavelengths greater than or equal to 800 nm and less than or equal to 2500 nm, and “LiDAR” refers to electromagnetic radiation with wavelengths greater than or equal to 905 nm and less than or equal to 1550 nm.

As used herein, the term “visible spectrum” refers to electromagnetic radiation with wavelengths greater than or equal to 350 nm and less than or equal to 750 nm.

The LiDAR reflecting dark colored paint may be disposed on surfaces to provide a LiDAR reflecting dark colored surface. Non-limiting examples include surfaces of vehicle body panels such as vehicle door panels, vehicle quarter panels, and the like. Utilization of the LiDAR reflecting copper oxide crystallites allow dark colored vehicles to be detected with a LiDAR system. Various embodiments of LiDAR reflecting copper oxide crystallites and methods for making and using the same will be described in further detail herein with specific reference to the appended drawings.

One difficulty in forming dark-colored (such as black) particles and paint systems that reflect LiDAR or near-IR electromagnetic radiation is the close proximity of the visible spectrum of electromagnetic radiation and near-IR electromagnetic radiation or LiDAR. Materials that provide a dark color, such as black, do not reflect electromagnetic radiation within the visible spectrum of electromagnetic radiation. Such materials will generally also not reflect electromagnetic radiation just outside of the visible spectrum of electromagnetic radiation, such as near-IR and LiDAR electromagnetic radiation. Carbon black is one such material that is commonly used as a dark pigment and that does not reflect electromagnetic radiation in the visible spectrum and that also does not reflect near-IR or LiDAR electromagnetic radiation. Accordingly, a material that does not reflect electromagnetic radiation within the visible spectrum but that does reflect near-IR or LiDAR electromagnetic radiation is required to have a very sharp increase in reflectivity just outside of the visible spectrum of electromagnetic radiation.

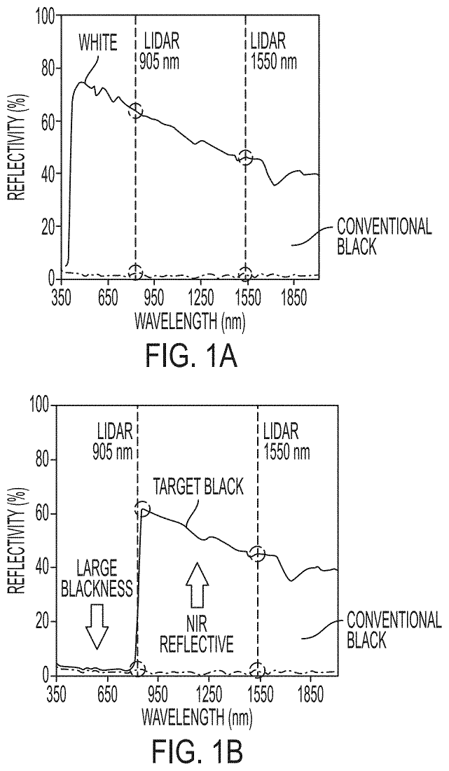

With reference now to FIG. 1A, the reflectivity of materials that are commonly used as colorants in a paint system are shown. The percentage of reflectivity is presented along the y-axis of FIG. 1A and the wavelength of the electromagnetic radiation is provided along the x-axis of FIG. 1A. The reflectivity of a conventional black colorant, such as carbon black, is shown along the bottom of the graph. As shown in FIG. 1A, the carbon black colorant does not reflect electromagnetic radiation in the visible spectrum (to the left of the graph). Namely, the reflection of this black colorant is near zero percent within the visible spectrum of electromagnetic radiation. This indicates that the colorant provides a dark, nearly pure black color. However, this conventional colorant also reflects around zero percent of electromagnetic radiation outside of the visible spectrum (to the right on the graph), such as near-IR electromagnetic radiation or LiDAR electromagnetic radiation (e.g., from greater than about 750 nanometers (nm) to about 1550 nm). Similarly, near the top of the graph is shown the reflectivity of white TiO₂, which is used as a conventional white colorant. As shown in FIG. 1A, white TiO₂ reflects near-IR and LiDAR electromagnetic radiation as shown on the right side of the graph (e.g., from greater than about 750 nm to 1550 nm) where the reflection of near-IR and LiDAR electromagnetic radiation is greater than forty percent (at 1550 nm), and around sixty percent (at 905 nm). However, white TiO₂, as the name indicates, also reflects electromagnetic radiation within the visible spectrum. As shown in FIG. 1A, white TiO₂ reflects nearly eighty percent of electromagnetic radiation within the visible spectrum. Accordingly, neither of these colorants—carbon black or white TiO₂—are suitable as a dark-colored particle that also reflects near-IR or LiDAR electromagnetic radiation.

FIG. 1B is a graph showing the target conditions of a particle that does not reflect light in the visible spectrum of electromagnetic radiation, but that does reflect near-IR and LiDAR electromagnetic radiation. In FIG. 1B, the percentage of reflectivity is measured along the y-axis and the wavelength of electromagnetic radiation is provided along the x-axis. Along the bottom of the graph is shown the reflectivity of a conventional black colorant, which is identical to the reflectivity of the conventional black colorant (such as carbon black) shown in FIG. 1A. As shown in FIG. 1B, particles that do not reflect electromagnetic within the visible spectrum and that reflect near-IR and LiDAR electromagnetic radiation have at least two distinct regions of reflection. The first region of reflection is within the visible spectrum of electromagnetic radiation, indicated on the left side of the graph in FIG. 1B. In this region of reflection, particles that do not reflect electromagnetic within the visible spectrum and that reflect near-IR and LiDAR electromagnetic radiation will behave the same as conventional black colorants (such as carbon black) by not reflecting electromagnetic radiation within the visible spectrum. As shown in FIG. 1B, particles that do not reflect electromagnetic within the visible spectrum and that reflect near-IR and LiDAR electromagnetic radiation reflect nearly zero percent of electromagnetic radiation within the visible spectrum. However, particles that do not reflect electromagnetic within the visible spectrum and that reflect near-IR and LiDAR electromagnetic radiation have a second region of reflection that is outside of the visible spectrum of electromagnetic radiation.

The second region of reflection encompasses electromagnetic radiation with wavelengths greater than or equal to 750 nm and less than or equal to 1050 nm (which includes near-IR and LiDAR electromagnetic radiation). In the second region of reflection, the particles that do not reflect electromagnetic within the visible spectrum and that reflect near-IR and LiDAR electromagnetic radiation perform similarly as white TiO₂ by reflecting a high amount of electromagnetic radiation within the second region of reflection. As shown in FIG. 1B, particles that do not reflect electromagnetic within the visible spectrum and that reflect near-IR and LiDAR electromagnetic radiation reflect, for example, about sixty percent of LiDAR electromagnetic radiation having a wavelength of 905 nm and reflects greater than forty percent of LiDAR electromagnetic radiation having a wavelength of 1550 nm. By having reflectance in the second region of reflection that is similar to white TiO₂, particles can reflect a sufficient amount of near-IR and LiDAR electromagnetic radiation that the particles can be detected by LiDAR systems.

FIG. 1B shows the difficulty in forming particles that do not reflect electromagnetic within the visible spectrum and that reflect near-IR and LiDAR electromagnetic radiation. Particularly, FIG. 1B shows a steep increase in reflectance just outside of the visible spectrum of electromagnetic radiation. In embodiments, this steep increase of reflectance is present at a wavelength of electromagnetic radiation that is at or about 905 nm, which is a wavelength of electromagnetic radiation commonly used in LiDAR systems. As shown in FIG. 1B, the reflectance increases from about zero percent to nearly sixty percent at a wavelength of electromagnetic radiation that is about 905 nm. Forming a particle with such a precise and steep increase in reflectance is difficult to achieve and there is very little room for error. For instance, if the material reflects too much electromagnetic radiation within the visible spectrum, the appearance of the color will not be pure black, but will have hints of, for example, red or purple. However, if the material does not reflect a sufficient amount of near-IR or LiDAR electromagnetic radiation, the material will not be suitable for detection by LiDAR systems.

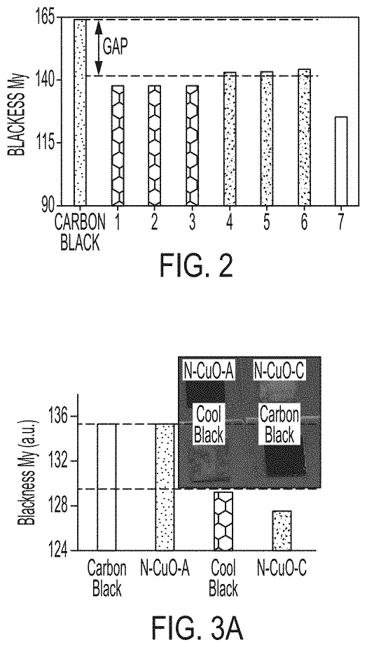

Some materials do not reflect electromagnetic radiation within much of the visible spectrum and reflect near-IR and LiDAR electromagnetic radiation; however, these materials have not been able to reproduce the visible appearance of carbon black (i.e., has a reflectivity of about zero percent for electromagnetic radiation within the visible spectrum). One such material that has gained interest is chromium iron oxide and derivatives thereof. Although chromium iron oxide materials can generally reflect near-IR and LiDAR electromagnetic radiation, colorants made from chromium iron oxide materials are generally referred to as “cool black” because colorants made from chromium iron oxide or derivatives thereof have hints of red or blue in them. FIG. 2 is a bar graph that shows the blackness of various materials on the y-axis. Blackness is measured by X-Rite Spectrophotometer. At the far left of FIG. 2 is carbon black, which is the material commonly used as a black colorant, but carbon black does not reflect near-IR or LiDAR electromagnetic radiation. As shown in FIG. 2, carbon black has a blackness of about 165. Materials 1-7 are chromium iron oxide containing materials that reflect near-IR and LiDAR electromagnetic radiation, but as can be seen in FIG. 2, these materials have a blackness that is around 142 or less. This difference in blackness is notable, as materials 1-7 have tints of red or blue. Thus, this considerable gap in blackness between carbon black and materials 1-7 show that materials 1-7 are generally not suitable to be used in applications where pure black is desired, such as, for example, in paint for automotive applications, textiles, and the like. Consequently, there is a need for a durable and inexpensive pigment that has a blackness similar to carbon black, such as pigment from Cabot Corporation (denoted as “Carbon Black”), and that also reflects near-IR and LiDAR electromagnetic radiation.

Without being bound by any particular theory, it is believed that the sharp transition of reflectivity (or absorbance) between 700 nm wavelength and 905 nm wavelength electromagnetic radiation is attributed to the near unity ratio of (−111)/(111) crystal facets and at a crystal size around 100 Å for the (−111) plane.

One material of interest for black color applications is Copper (II) oxide or cupric oxide (CuO). CuO is a common inorganic compound that is a black-colored solid material in its natural state. However, not all copper oxides have this black color. Namely, another stable oxide of copper is cuprous oxide (Cu₂O) that is a red solid in its natural state. Therefore, the oxidation state of copper is important to ensure that the material has a black color. CuO is a product of copper mining and it is a precursor to many other copper-containing products and chemical compounds. CuO has been used as a black pigment in certain applications, such as in ceramics, glazes, and the like. However, commonly used CuO does not reflect near-IR or LiDAR electromagnetic radiation. That is, CuO in its natural state behaves much like carbon black in that it does not reflect electromagnetic radiation in the visible spectrum and it also does not reflect electromagnetic radiation in the near-IR or LiDAR spectrum. Without being bound to any particular theory, CuO has a band gap of 2.0 eV that, as described in more detail below, does not readily reflect electromagnetic radiation in the near-IR or LiDAR spectrum. When manipulating CuO to have a band gap that is more amenable to reflecting electromagnetic radiation in the near-IR or LiDAR spectrum, the color of the CuO degrades to a brownish black, which is not suitable for certain applications, such as in an automotive paint, textiles, and the like.

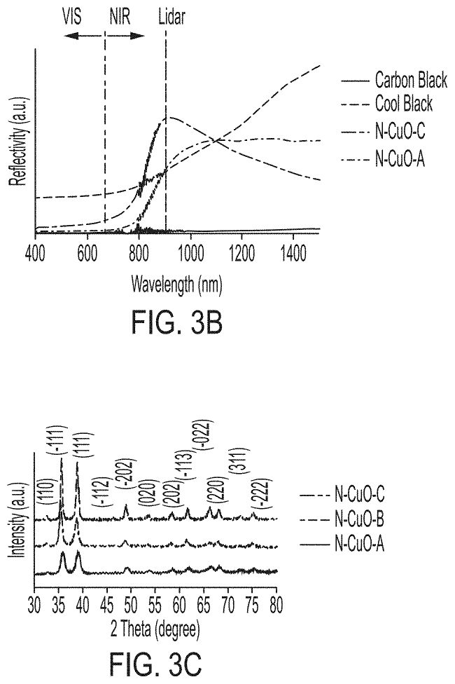

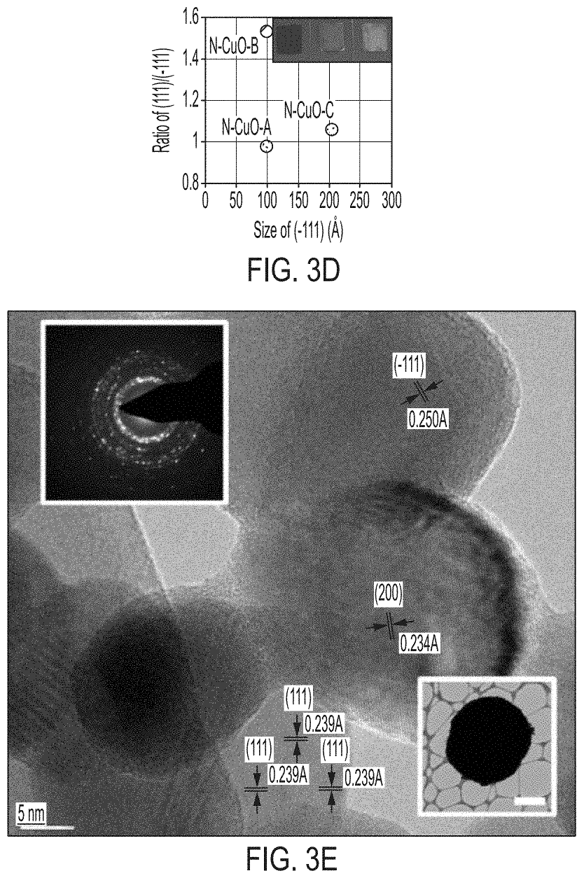

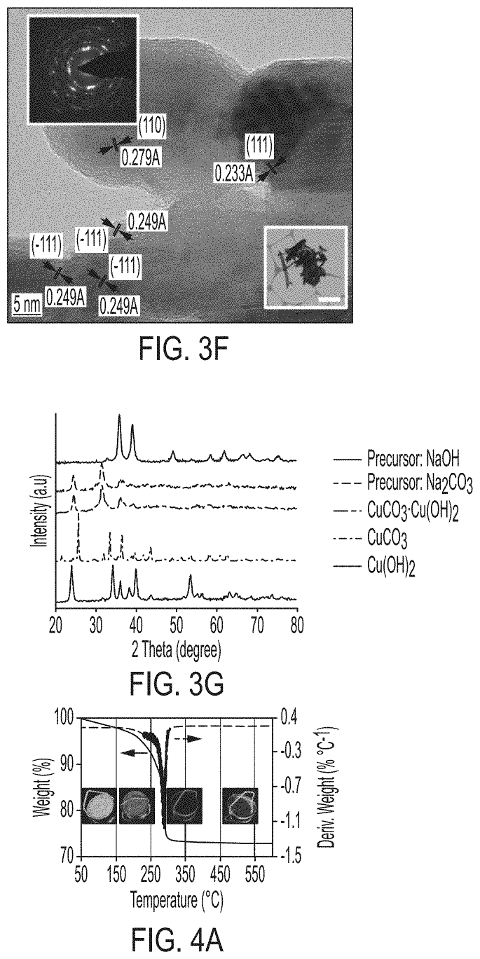

Paint containing carbon black exhibits very low reflection (less than 1%) throughout the visible and near-IR wavelength resulting in high blackness My value around 135. Paints with commercial CuO have higher near-IR reflectivity selectively of wavelengths of electromagnetic radiation wavelengths from 900 nm to 1000 nm, but commercial CuO shows distinguishable reflection in visible wavelength particularly in red hue, resulting in obvious brownish tone appearance with blackness My value less than 130. On the other hand, “cool black” shows strong reflection in the deeper end of the near-IR spectra at electromagnetic radiation wavelengths greater than 905 nm yet does not sufficiently absorb in the visible wavelengths with blackness My value of 128. Insert photo in FIG. 3A shows the difference in blackness of these raw pigment samples, shows the practical application of the reflectance spectra in visible range as paint samples, as shown in FIG. 3B. In the figures, N-CuO-C is commercial CuO and N-CuO-A is CuO according to embodiments disclosed and described herein. One way of determining this transition of low reflectivity in the visible spectrum of electromagnetic radiation to high reflectivity at near-IR and LiDAR electromagnetic radiation is by evaluating the band gap of a material.

The band gap generally refers to the energy difference (in electron volts or eV) between the top of the valence band (VB) and the bottom of the conduction band (CB). The VB is the band of electron orbitals that electrons can jump out of, moving into the CB when excited. The VB is the outermost electron orbital of an atom that electrons can actually occupy. The band gap is the energy required for an electron to move from the VB to the CB and can be indicative of the electrical conductivity of the material. In optics, the band gap correlates to the threshold where photons can be absorbed by a material. Therefore, without begin bound by any particular theory, the band gap determines what portion of the electromagnetic spectrum the material can absorb. Generally, a material with a large band gap will absorb a greater portion of electromagnetic spectra having a short wavelength, and a material with a small band gap will absorb a greater portion of electromagnetic spectra having long wavelengths. Put differently, a large band gap means that a lot of energy is required to excite valence electrons to the CB. In contrast, when the valence band and conduction band overlap as they do in metals, electrons can readily jump between the two bands, which means that the material is highly conductive. However, it has been found that by manipulating the band gap of a material, the types of electromagnetic spectra that are absorbed by the material may be controlled. In view of this, materials with bandgap energy near the LiDAR detection electromagnetic radiation wavelength (around 905 nm) have a band gap around 1.37 eV and sharp transition at the visible edge (around 700 nm) and are promising candidates as materials that do not reflect visible electromagnetic radiation but that do reflect near-IR and LiDAR electromagnetic radiation.

Cupric (II) oxide (CuO) is a monoclinic p-type semiconductor with fundamental bandgap of indirect nature. The experimental values of its indirect bandgap have been determined to be in the range of 1.2 eV to 2.2 eV. CuO compounds have been studied widely in areas such as solar energy materials, gas sensors, magnetic media, optical devices, batteries, catalyst, as well as constructing junction devices and superconducting materials. It has also been emphasized that the bandgap of CuO is tunable by means of different approaches such as dopants, synthesis solvent and stoichiometry, nanoparticle size, and the shape of the nanostructure as well as the morphology. Currently, the bandgap engineering studies of CuO focus on an optical response to solar radiation and its catalytic behavior. However, there is no disclosure directed to tailoring CuO to absorb wavelengths in the visible spectrum of electromagnetic radiation and to reflect electromagnetic radiation wavelengths in near-IR and LiDAR spectrum. There have been past efforts to improve the blackness of CuO by physically tailoring the particle size via ball milling or other techniques. However, it has not been possible to mill CuO to reach the blackness level of carbon black.

Generally, a band gap of from 1.2 eV to 1.8 eV is required for a compound to absorb (i.e., not reflect) electromagnetic radiation in the visible spectrum and reflect electromagnetic radiation in the near-IR and LiDAR spectrum. Without manipulation, bulk CuO does not meet these requirements. Bulk CuO has a reported band gap of 2.0 eV and a blackness My value of 128. This band gap is outside of the 1.2 eV to 1.8 eV required to reflect electromagnetic radiation in the near-IR and LiDAR spectrum. Further, as noted above with reference to FIG. 2, a blackness of 128 is significantly lower than the blackness of about 165 for carbon black. Accordingly, in embodiments disclosed and described herein, methods for forming CuO crystallites having significantly reduced particle sizes that result in a decrease the bandgap and increase in the blackness of CuO are provided.

In embodiments, a synthesis of a type of CuO crystallites (also referred to herein as “N-CuO-A”) that may be used as a replacement for carbon black and show superior blackness in the visible spectrum of electromagnetic radiation while also having high reflectivity in near-IR and LiDAR electromagnetic radiation wavelengths are provided. The N-CuO-A may, in embodiments be synthesized via scalable precipitation-pyrolysis method—with proper selection in precipitating agents at certain concentration ranges—that is followed by a well-defined sintering process. Structural and chemical composition studies depict the evolution from precursor to extracted precipitates, and to final CuO crystallites at various process stages. As referenced above, two key indicators in XRD spectra to guide the experimental conditions towards the desired crystal structure and resultant optical contrast in both visible and near-IR range were unexpectedly discovered. Painted panels prepared by incorporating N-CuO-A in paint medium confirmed blackness behavior and LiDAR sensing operation in comparison to carbon black.

A comparison of different CuO particles obtained from the precursor Cu(NO₃)₂ with different alkaline bases generally used to synthesize CuO, namely, a weak base Na₂CO₃ for N-CuO-A and a strong base NaOH for the other CuO particles (referred to herein as “N-CuO-B”) provides understanding of the origin of significantly higher blackness and near-IR or LiDAR reflection in certain CuO crystallites. N-CuO-A and N-CuO-B are prepared following the same sintering conditions in a conventional oven (300° C. for 3 hours) to provide the comparison. Commercial nanostructured CuO (referred to herein as “N-CuO-C”) is a reference for comparison to N-CuO-A and N-CuO-B. FIG. 3C shows XRD profiles of these CuO samples. It reveals that all the samples are pure cupric (II) oxide with a monoclinic structure, and approximately corresponding with JCPDS No. 03-065-2309. The diffraction peaks at 20 values of 33.5°, 35.5°, 38.2°, 48.7°, 54.2°, 58.3°, 62.5°, 66.4°, 68.2°, 73.4°, and 75.6° are observed for all of the samples, which correspond respectively to the lattice planes of (110), (−111), (111), (−112), (−202), (020), (202), (−113), (220), (311), and (−222). Among those planes, the intensity of (−111) and (111) peaks is much stronger than that of other peaks, which indicates this orientation of the formed nanocrystals along these directions provides the type of reflectivity desired according to embodiments. No peaks of impurity phases such as Cu₂O are detected. The relatively broad XRD peaks in N-CuO-A and N-CuO-B indicate that the size of crystals in both N-CuO-A and N-CuO-B are both relatively small (about 100 Å) under provided sintering conditions. Comparatively, the XRD profile of N-CuO-C shows much narrower and sharper peaks, indicating larger crystallite sizes (about 204 Å). Though N-CuO-A and N-CuO-B have similar crystallite size, a close look on the XRD spectra reveals that the relative intensity ratio between the two major lattice planes (−111) and (111) in N-CuO-A and N-CuO-B are significantly different.

As seen from FIG. 3C, N-CuO-A does show relatively smaller ratio of (−111)/(111) than N-CuO-B. According to the calculated potential of the low-index surfaces of CuO using DFT method, (111) plane has a valence band maximum edge (VBM) near 1.2 eV (or about 1030 nm) with a bandgap energy of 1.5 eV, while (−111) plane has a slightly larger VBM around 2.1 eV (or about 620 nm) with a slightly larger bandgap energy of 1.6 eV. Accordingly, visual observation indicates that (−111) plane is the major cause for visible reflection as it starts from a larger VBM around 620 nm. Therefore, smaller ratio of (−111)/(111) or smaller crystallite size of (−111) plane would potentially lead to higher blackness level, while larger ratio and crystallite size would benefit near-IR or LiDAR reflectivity.

As seen in FIG. 3D, N-CuO-A has lowest ratio and smallest crystallite size, and it has highest level of blackness but relatively weaker near-IR reflectivity (left sample in the insert for FIG. 3D). Samples that have either larger crystallite size (e.g., N-CuO-C) (right sample in the insert of FIG. 3D) or a relatively higher ratio of (−111)/(111) (e.g., N-CuO-B) show brownish color (middle sample in the insert of FIG. 3D). The near-IR reflections in these two samples are higher due to the dominant (−111) plane (N-CuO-B) or the larger average crystallite size of (−111) plane (N-CuO-C). Therefore, without being bound by any particular theory, it is believed that these are two key indicators for materials that will absorb electromagnetic radiation in the visible spectrum and reflect electromagnetic radiation in the near-IR and LiDAR spectrums; the ratio of (−111)/(111) planes in the crystallite phases and the average crystallite size of the resultant CuO crystallites. According to embodiments, maintaining a balance of the ratio (−111)/(111) around 1 and the crystallite size of (−111) around 100 Å help achieve LiDAR reflectivity and visual blackness.

FIGS. 3E and 3F are HR-TEM images taken from synthesized N-CuO-A and N-CuO-B, respectively that reveal their differences in both agglomerates and smaller crystallites. N-CuO-A shows microspherical agglomerates made of connected nanospheres having a diameter on the scale of tens of nanometers, as shown in the bottom insert of FIG. 3E, while N-CuO-B is composed of nanorod like aggregates in a width on the scale of tens of nanometers but a length of 1 μm, as shown in the bottom insert of FIG. 3F. For N-CuO-A, several interplanar spacings in the primary N-CuO-A crystallites are indexed as 0.239 Å, 0.250 Å, 0.234 Å, corresponding to the (111), (−111) and (200) planes, respectively, as shown in FIG. 3E. The relatively equal intensity ratio of (−111)/(111) is almost unity as specified by XRD profile, which agrees with the observation of a few diffraction spots with relatively similar brightness in the selected-area electron diffraction (SAED) pattern, as shown in the top insert of FIG. 3E. On the contrary, intensified spots in the SEAD pattern are observed in N-CuO-B, which agrees with the relatively higher ratio of (−111)/(111) in XRD profile, indicating a preferential orientation of the nanocrystals, as shown in FIG. 3F. One of the dominant planes was indexed as the (−111) plane that contributes to higher intensity of both near-IR and undesired visible reflectivity. The nanocrystals of similar orientation are easy to connect and grow together; the aggregating rate at one preferred direction is faster than along other directions, leading to the formation of CuO nanorods of N-CuO-B.

Accordingly, in embodiments, the ratio of (−111)/(111) may be greater than or equal to 0.8 and less than or equal to 1.3, such as greater than or equal to 0.9 and less than or equal to 1.3, greater than or equal to 1.0 and less than or equal to 1.3, greater than or equal to 1.1 and less than or equal to 1.3, greater than or equal to 1.2 and less than or equal to 1.3, greater than or equal to 0.8 and less than or equal to 1.2, greater than or equal to 0.9 and less than or equal to 1.2, greater than or equal to 1.0 and less than or equal to 1.2, greater than or equal to 1.1 and less than or equal to 1.2, greater than or equal to 0.8 and less than or equal to 1.1, greater than or equal to 0.9 and less than or equal to 1.1, greater than or equal to 1.0 and less than or equal to 1.1, greater than or equal to 0.8 and less than or equal to 1.0, greater than or equal to 0.9 and less than or equal to 1.0, or greater than or equal to 0.8 and less than or equal to 0.9.

By reducing the size of CuO particles, such as to the average particle sizes disclosed below, the band gap of the CuO decreases. In embodiments, the band gap as measured by X-ray photoelectron spectroscopy (XPS) of the CuO nanoparticles is greater than or equal to 1.2 eV and less than or equal to 1.8 eV, such as greater than or equal to 1.3 eV and less than or equal to 1.8 eV, greater than or equal to 1.4 eV and less than or equal to 1.8 eV, greater than or equal to 1.5 eV and less than or equal to 1.8 eV, greater than or equal to 1.6 eV and less than or equal to 1.8 eV, greater than or equal to 1.7 eV and less than or equal to 1.8 eV, is greater than or equal to 1.2 eV and less than or equal to 1.7 eV, such as greater than or equal to 1.3 eV and less than or equal to 1.7 eV, greater than or equal to 1.4 eV and less than or equal to 1.7 eV, greater than or equal to 1.5 eV and less than or equal to 1.7 eV, greater than or equal to 1.6 eV and less than or equal to 1.7 eV, greater than or equal to 1.2 eV and less than or equal to 1.6 eV, such as greater than or equal to 1.3 eV and less than or equal to 1.6 eV, greater than or equal to 1.4 eV and less than or equal to 1.6 eV, greater than or equal to 1.5 eV and less than or equal to 1.6 eV, greater than or equal to 1.2 eV and less than or equal to 1.5 eV, such as greater than or equal to 1.3 eV and less than or equal to 1.5 eV, greater than or equal to 1.4 eV and less than or equal to 1.5 eV, greater than or equal to 1.2 eV and less than or equal to 1.4 eV, such as greater than or equal to 1.3 eV and less than or equal to 1.4 eV, or greater than or equal to 1.2 eV and less than or equal to 1.3 eV.

Without being bound by any particular theory, it is believed that the smaller the average crystal size of the CuO nanoparticles, the lower the band gap of the CuO nanoparticles will be. Thus, by reducing bulk CuO particles to CuO nanoparticles according to embodiments disclosed and described herein, the band gap of the CuO nanoparticles is within the range that will reflect electromagnetic radiation within the near-IR and LiDAR spectrum, such as having a band gap that is between 1.5 eV and 2.0 eV.

In embodiments, the CuO crystallites may have an average particle size that is greater than or equal to 5 nm and less than or equal to 15 nm, such as greater than or equal to 6 nm and less than or equal to 15 nm, greater than or equal to 7 nm and less than or equal to 15 nm, greater than or equal to 8 nm and less than or equal to 15 nm, greater than or equal to 9 nm and less than or equal to 15 nm, greater than or equal to 10 nm and less than or equal to 15 nm, greater than or equal to 11 nm and less than or equal to 15 nm, greater than or equal to 12 nm and less than or equal to 15 nm, greater than or equal to 13 nm and less than or equal to 15 nm, greater than or equal to 14 nm and less than or equal to 15 nm, greater than or equal to 5 nm and less than or equal to 14 nm, greater than or equal to 6 nm and less than or equal to 14 nm, greater than or equal to 7 nm and less than or equal to 14 nm, greater than or equal to 8 nm and less than or equal to 14 nm, greater than or equal to 9 nm and less than or equal to 14 nm, greater than or equal to 10 nm and less than or equal to 14 nm, greater than or equal to 11 nm and less than or equal to 14 nm, greater than or equal to 12 nm and less than or equal to 14 nm, greater than or equal to 13 nm and less than or equal to 14 nm, greater than or equal to 5 nm and less than or equal to 13 nm, greater than or equal to 6 nm and less than or equal to 13 nm, greater than or equal to 7 nm and less than or equal to 13 nm, greater than or equal to 8 nm and less than or equal to 13 nm, greater than or equal to 9 nm and less than or equal to 13 nm, greater than or equal to 10 nm and less than or equal to 13 nm, greater than or equal to 11 nm and less than or equal to 13 nm, greater than or equal to 12 nm and less than or equal to 13 nm, greater than or equal to 5 nm and less than or equal to 12 nm, greater than or equal to 6 nm and less than or equal to 12 nm, greater than or equal to 7 nm and less than or equal to 12 nm, greater than or equal to 8 nm and less than or equal to 12 nm, greater than or equal to 9 nm and less than or equal to 12 nm, greater than or equal to 10 nm and less than or equal to 12 nm, greater than or equal to 11 nm and less than or equal to 12 nm, greater than or equal to 5 nm and less than or equal to 11 nm, greater than or equal to 6 nm and less than or equal to 11 nm, greater than or equal to 7 nm and less than or equal to 11 nm, greater than or equal to 8 nm and less than or equal to 11 nm, greater than or equal to 9 nm and less than or equal to 11 nm, greater than or equal to 10 nm and less than or equal to 11 nm, greater than or equal to 5 nm and less than or equal to 10 nm, greater than or equal to 6 nm and less than or equal to 10 nm, greater than or equal to 7 nm and less than or equal to 10 nm, greater than or equal to 8 nm and less than or equal to 10 nm, greater than or equal to 9 nm and less than or equal to 10 nm, greater than or equal to 5 nm and less than or equal to 9 nm, greater than or equal to 6 nm and less than or equal to 9 nm, greater than or equal to 7 nm and less than or equal to 9 nm, greater than or equal to 8 nm and less than or equal to 9 nm, greater than or equal to 5 nm and less than or equal to 8 nm, greater than or equal to 6 nm and less than or equal to 8 nm, greater than or equal to 7 nm and less than or equal to 8 nm, greater than or equal to 5 nm and less than or equal to 7 nm, greater than or equal to 6 nm and less than or equal to 7 nm, or greater than or equal to 5 nm and less than or equal to 6 nm.

The blackness My (i.e., a measure of blackness) of the CuO crystallites is, in embodiments, greater than or equal to 130 and less than or equal to 170, such as greater than or equal to 135 and less than or equal to 170, greater than or equal to 140 and less than or equal to 170, greater than or equal to 145 and less than or equal to 170, greater than or equal to 150 and less than or equal to 170, greater than or equal to 155 and less than or equal to 170, greater than or equal to 160 and less than or equal to 170, greater than or equal to 165 and less than or equal to 170, greater than or equal to 130 and less than or equal to 165, greater than or equal to 135 and less than or equal to 165, greater than or equal to 140 and less than or equal to 165, greater than or equal to 145 and less than or equal to 165, greater than or equal to 150 and less than or equal to 165, greater than or equal to 155 and less than or equal to 165, greater than or equal to 160 and less than or equal to 165, greater than or equal to 130 and less than or equal to 160, greater than or equal to 135 and less than or equal to 160, greater than or equal to 140 and less than or equal to 160, greater than or equal to 145 and less than or equal to 160, greater than or equal to 150 and less than or equal to 160, greater than or equal to 155 and less than or equal to 160, greater than or equal to 130 and less than or equal to 155, greater than or equal to 135 and less than or equal to 155, greater than or equal to 140 and less than or equal to 155, greater than or equal to 145 and less than or equal to 155, greater than or equal to 150 and less than or equal to 155, greater than or equal to 130 and less than or equal to 150, greater than or equal to 135 and less than or equal to 150, greater than or equal to 140 and less than or equal to 150, greater than or equal to 145 and less than or equal to 150, greater than or equal to 130 and less than or equal to 145, greater than or equal to 135 and less than or equal to 145, greater than or equal to 140 and less than or equal to 145, greater than or equal to 130 and less than or equal to 140, greater than or equal to 135 and less than or equal to 140, or greater than or equal to 130 and less than or equal to 135.

Copper oxide crystallites according to embodiments disclosed and described herein have a reflectivity in the visible spectrum of electromagnetic radiation that is less than or equal to 10.0%, such as less than or equal to 9.0%, less than or equal to 8.0%, less than or equal to 7.0%, less than or equal to 6.0%, less than or equal to 5.0%, less than or equal to 4.0%, less than or equal to 3.0%, less than or equal to 2.0%, less than or equal to 1.0%, or less than or equal to 0.5%.

Copper oxide crystallites according to embodiments disclosed and described herein have a reflectivity in the near-IR and LiDAR spectrum of electromagnetic radiation that is greater than or equal to 10%, such as greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, or greater than or equal to 60%. In one or more embodiments, the copper oxide crystallites have a reflectivity in the near-IR and LiDAR spectrum of electromagnetic radiation that is greater than or equal to 10% and less than or equal to 60%, such as greater than or equal to 15% and less than or equal to 60%, greater than or equal to 20% and less than or equal to 60%, greater than or equal to 25% and less than or equal to 60%, greater than or equal to 30% and less than or equal to 60%, greater than or equal to 35% and less than or equal to 60%, greater than or equal to 40% and less than or equal to 60%, greater than or equal to 45% and less than or equal to 60%, greater than or equal to 50% and less than or equal to 60%, greater than or equal to 55% and less than or equal to 60%, greater than or equal to 10% and less than or equal to 55%, greater than or equal to 15% and less than or equal to 55%, greater than or equal to 20% and less than or equal to 55%, greater than or equal to 25% and less than or equal to 55%, greater than or equal to 30% and less than or equal to 55%, greater than or equal to 35% and less than or equal to 55%, greater than or equal to 40% and less than or equal to 55%, greater than or equal to 45% and less than or equal to 55%, greater than or equal to 50% and less than or equal to 55%, greater than or equal to 10% and less than or equal to 50%, greater than or equal to 15% and less than or equal to 50%, greater than or equal to 20% and less than or equal to 50%, greater than or equal to 25% and less than or equal to 50%, greater than or equal to 30% and less than or equal to 50%, greater than or equal to 35% and less than or equal to 50%, greater than or equal to 40% and less than or equal to 50%, greater than or equal to 45% and less than or equal to 50%, greater than or equal to 10% and less than or equal to 45%, greater than or equal to 15% and less than or equal to 45%, greater than or equal to 20% and less than or equal to 45%, greater than or equal to 25% and less than or equal to 45%, greater than or equal to 30% and less than or equal to 45%, greater than or equal to 35% and less than or equal to 45%, greater than or equal to 40% and less than or equal to 45%, greater than or equal to 10% and less than or equal to 40%, greater than or equal to 15% and less than or equal to 40%, greater than or equal to 20% and less than or equal to 40%, greater than or equal to 25% and less than or equal to 40%, greater than or equal to 30% and less than or equal to 40%, greater than or equal to 35% and less than or equal to 40%, greater than or equal to 10% and less than or equal to 35%, greater than or equal to 15% and less than or equal to 35%, greater than or equal to 20% and less than or equal to 35%, greater than or equal to 25% and less than or equal to 35%, greater than or equal to 30% and less than or equal to 35%, greater than or equal to 10% and less than or equal to 30%, greater than or equal to 15% and less than or equal to 30%, greater than or equal to 20% and less than or equal to 30%, greater than or equal to 25% and less than or equal to 30%, greater than or equal to 10% and less than or equal to 25%, greater than or equal to 15% and less than or equal to 25%, greater than or equal to 20% and less than or equal to 25%, greater than or equal to 10% and less than or equal to 20%, greater than or equal to 15% and less than or equal to 20%, or greater than or equal to 10% and less than or equal to 15%.

Methods for making CuO crystallites according to embodiments will now be described.

The evolution of the crystal structure and size were studied from the precursors to extracted precipitates, and to the final products N-CuO-A obtained after sintering. First, for comparison, different precipitating agents of NaOH and Na₂CO₃ having a constant Cu/Na molar ratio of 0.65 were used. The XRD profile of the extracted precipitates that formed right after precipitation from the solution and prior to the sintering step are shown in FIG. 3G. The XRD profiles of the pure chemicals Cu(OH)₂, CuCO₃ and malachite CuCO₃.Cu(OH)₂ are shown as references in FIG. 3G. Without being bound by any particular theory, the reactions involved, when Na₂CO₃ was used, are in reactions from (1) to (4) below, where Reaction (2) and (4) lead to the formation of CuO. The precipitate formed using Na₂CO₃ shows lime green color in the air and exhibits similar XRD peaks as reference CuCO₃.Cu(OH)₂ with main peaks at 32° and is believed to follows Reaction (1); no peaks of CuCO₃ can be identified. Sintering at higher temperature is required for the malachite to become CuO according to Reaction (2).

On the other hand, the extracted precipitate obtained by using NaOH shows brownish black color, which exhibits similar XRD profiles as final product N-CuO-B in FIG. 3C. These characterizations confirm that the precipitation using NaOH follows Reactions (5) and (6) in an aqueous phase rather than Reaction (7) in solid phase. Copper hydroxide Cu(OH)₂ is known to be metastable and it is easily transforms into a more stable form copper (II) oxide. The kinetics of transformation to copper (II) oxide can be performed slowly in pure water at room temperature, but with presence of hydroxide ions OH⁻, it turns fast because the divalent copper ions are easily dissolved during the form of tetrahydroxocuprate (II) anions Cu(OH)₄²⁻, followed by the precipitation of CuO in Reaction (6). Here, the formation of CuO with (−111) plane as the growth plane was identified by XRD, which leads to high near-IR and LiDAR reflectivity but visually brownish, as shown in FIG. 3G. The subsequent sintering process at 300° C. would not reverse the ratio between (−111) and (111) planes or change the growth direction, but rather increases the size of crystalline planes, as shown in FIG. 3G.

Cu²⁺_{(aq)}+CO₃²⁻(ac)+H₂O→CuCO₃.Cu(OH)₂₍ₛ₎+CO_{2(g)} (1)

CuCO₃.Cu(OH)₂₍ₛ₎→2CuO₍ₛ₎+CO_{2(g)}+H₂O_{(g)} (2)

Cu²⁺_{(aq)}+CO₃²⁻_{(aq)}→CuCO₃₍ₛ₎ (3)

CuCO₃₍ₛ₎→CuO₍ₛ₎+CO_{2(g)} (4)

Cu²⁺_{(aq)}+2(OH)⁻_{(aq)}→Cu(OH)₂₍ₛ₎ (5)

Cu(OH)₂₍ₛ₎+2OH⁻_{(aq)}→Cu(OH)₄²⁻_{(aq)}↔CuO₍ₛ₎+2OH⁻_{(aq)}+H₂O (6)

Cu(OH)₂₍ₛ₎→CuO₍ₛ₎+H₂O_{(g)} (7)

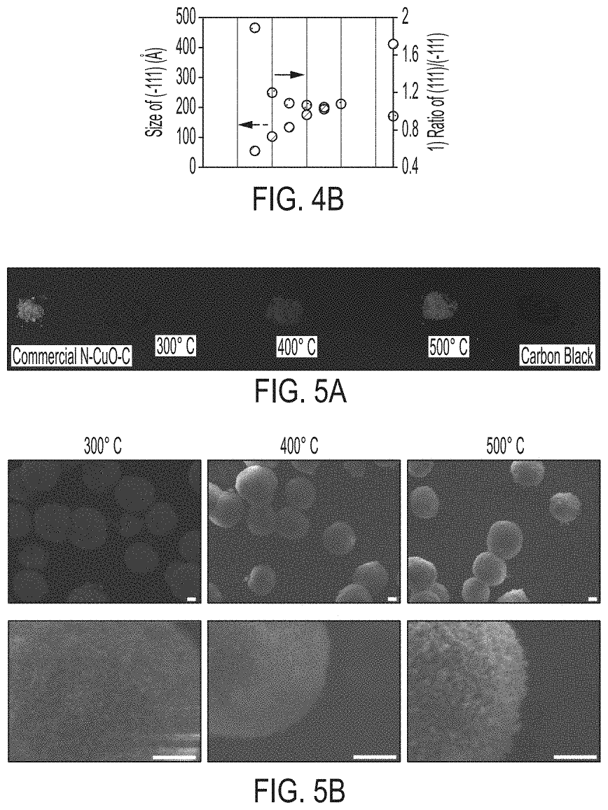

When using a Na₂CO₃ precipitating agent in the synthesis step, the extracted precipitate is identified as CuCO₃.Cu(OH)₂. Thermogravimetry analysis (TGA) is used to assess the pyrolysis process of converting CuCO₃.Cu(OH)₂ to N-CuO-A. The mass loss of water and carbon dioxide separately generated from Reaction (2) above can be determined by TGA, as well as the critical temperature when the conversion starts. Here, the obtained CuCO₃.Cu(OH)₂ was sintered from ambient temperature to 600° C. in the air via TGA. A major weight-loss of malachite during the pyrolysis process was observed between 200° C. to 300° C., due to the release of H₂O and CO₂. Visual observation indicates the malachite turns from original lime green color to orange color at about 200° C., then to jet-black color at 300° C., and to slightly brownish at higher temperatures. It is known that synthetic malachite decomposes thermally in a single step which was also confirmed by the single-peak DTA curve shown in FIG. 4A. CuO became stable at around 300° C. and above, as evident from TGA analysis shown in FIG. 4A and FIG. 4B.

These measurements show that the decomposition of CuCO₃.Cu(OH)₂ into CuO mainly happens between 250° C. to 300° C., which is where significant weight change happens. The weight-loss value of 28.1% in total at 300° C. indicates the molar ratio of CuCO₃ to Cu(OH)₂ is near unity, which further confirms the formation of pure malachite rather than CuCO₃ or Cu(OH)₂. Further increases in the annealing temperature above 300° C. would lead to negligible weight-loss but growth of CuO crystallites. FIG. 4B. On the other hand, shows that the relative intensity of (111)/(−111) is reduced significantly before 300° C. during conversion from malachite to CuO then becomes stable afterwards. At 300° C., CuO particles synthesized from Na₂CO₃ (such as N-CuO-A) at the Cu/Na molar ratio of 0.65 have the highest blackness comparing with counterparts at higher sintering temperatures or commercial N-CuO-C as shown in FIG. 5A, which corresponds with the results shown in FIG. 3D. The representative SEM images shown in FIG. 5B reveal that the materials sintered at higher temperature maintain their size of spherical agglomerates shape in the same range of 1 μm to 3 μm, but the nano-size particles become more inter-connected in the microspheres with nanoscale holes at higher sintering temperature. Therefore, their surface area decreases, as shown in FIG. 5B. Hence, the crystalline size of the nanocrystals, rather than the size of microspherical agglomerates, has main impact on the optical properties that shows a consistent increase in visible reflection with increasing crystalline size. The observation of the growth of crystal at higher sintering temperatures, with a decrease in surface area can be explained by the reduction in the numbers of vacancies of oxygen, vacancy cluster and local lattice disorder along with crystal growth. Therefore, this superior blackness at smaller crystalline size may be attributed to the higher crystallographic disorder that occurs just at the completion of the conversion from malachite to CuO. Therefore, in embodiments malachite originated CuO nanoparticles are annealed at the conversion temperature of 300° C.

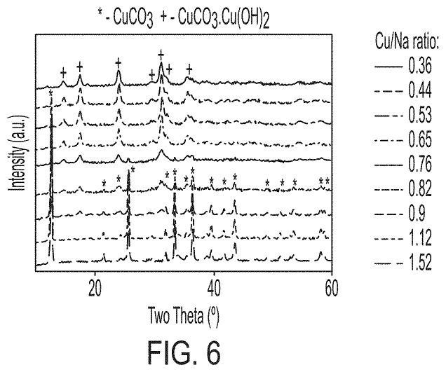

With the same precipitate agent Na₂CO₃ but at different molar ratios of Cu/Na (or level of carbonate concentration), it is possible to change the nucleation-growth route and to follow the route via Reaction (3)-(4) with CuCO₃ as the extracted precipitates. For such embodiments, a series of samples were prepared by varying the Cu/Na molar ratio from 1.52 (carbonate deficiency) to 0.36 (carbonate surplus). The XRD profiles of the extracted precipitates with varying Cu/Na molar ratios formed prior to the sintering process are presented in FIG. 6. The extracted precipitate samples with Cu/Na ratio 1.52 and 0.82 exhibit peaks of CuCO₃ with negligible presence of CuCO₃.Cu(OH)₂. These measurements show that the synthesis of CuO at higher Cu/Na ratios, such as 1.52 to 0.82, which corresponds to carbonate deficiency conditions, mainly follows Reaction (3)-(4) above. The intensity of the CuCO₃ peaks decreases when the Cu/Na ratio is decreased below 0.82, and new peaks of the malachite CuCO₃.Cu(OH)₂ start to appear. The samples with Cu/Na molar ratio at 0.76 exhibit peaks due to a mixture of CuCO₃ and CuCO₃.Cu(OH)₂ with the latter as dominant species. The CuCO₃ peaks completely diminished for the extracted precipitates with Cu/Na molar ratio less than 0.65 and only pure malachite peaks were observed. There is no significant change in the XRD peaks with further decrease in the Cu/Na molar ratio (or in excess of Na₂CO₃) and the extracted precipitate materials only exhibit peaks due to CuCO₃.Cu(OH)₂.

Table 1 below summarizes the XRD profiles of the resultant CuO samples with varying Cu/Na molar ratio, in terms of the crystallite size of (−111) plane and the intensity ratio of (−111)/(111). The crystallite size of CuO decreases with decreasing Cu/Na molar ratio until about 0.53 and further decrease in the Cu/Na molar ratio leads to minimal change in the crystallite size. On the other hand, there is no noticeable change in the (−111)/(111) ratio with changing Cu/Na molar ratio during the synthesis. All the samples exhibit the ratio of (−111)/(111) around 1.00±0.05.

TABLE 1
Crystallite size, ratio of (−111)/(111) planes for CuO
materials synthesized by varying Cu/Na molar ratios.

| | Crystallite size (Å) of | (−111)/(111) |
|---|---|---|
| Cu/Na ratio | (−111) | ratio |
| 1.52 | 199 | 0.99 |
| 1.12 | 196 | 1.01 |
| 0.9 | 143 | 0.97 |
| 0.76 | 128 | 1.03 |
| 0.65 | 104 | 1.03 |
| 0.53 | 81 | 1.04 |
| 0.48 | 81 | 1.05 |
| 0.36 | 79 | 1.05 |

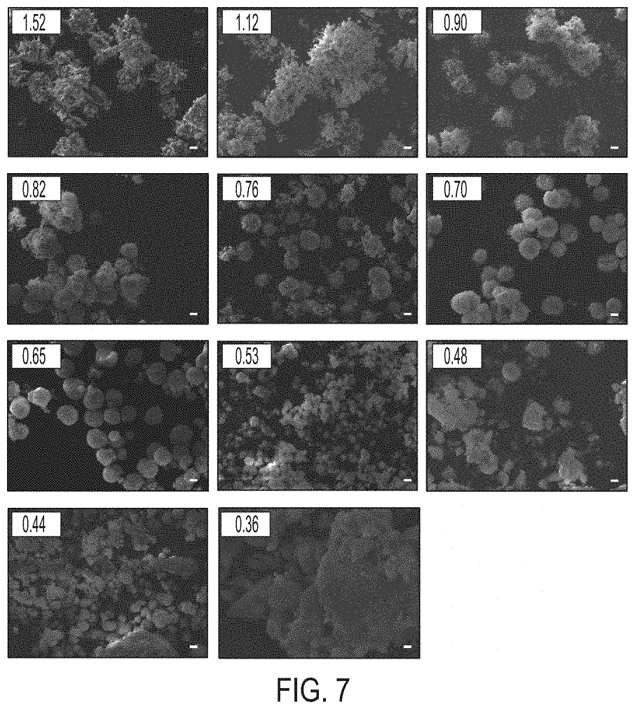

The SEM images of the CuO samples with varying Cu/Na molar ratio after the sintering are presented in FIG. 7. CuO samples with Cu/Na molar ratios 1.52 and 1.12 exhibit flower-like morphology with sharp spikes. When the Cu/Na molar ratio decreases down to 0.76, a mix of flower-like morphology and microspheres are observed. At a Cu/Na molar ratio between 0.76 to 0.65, the flower-like morphology disappears, and only microspheres are observed. Combined with XRD measurements, it can be concluded that the level of carbonate concentration affects the nucleation and growth, as well as the formation of precipitate. It is also clear that the formation of CuCO₃ during the precipitation leads to irregular flower-like morphology of CuO products, while the formation of CuCO₃.Cu(OH)₂ malachite tends to result in nearly monodisperse microspheres CuO products. Noticeably, the samples with Cu/Na molar ratios less than 0.65 exhibit irregular morphologies, even though XRD measurements show that these extracted precipitates only exhibit peaks of CuCO₃.Cu(OH)₂, as shown in FIG. 6.

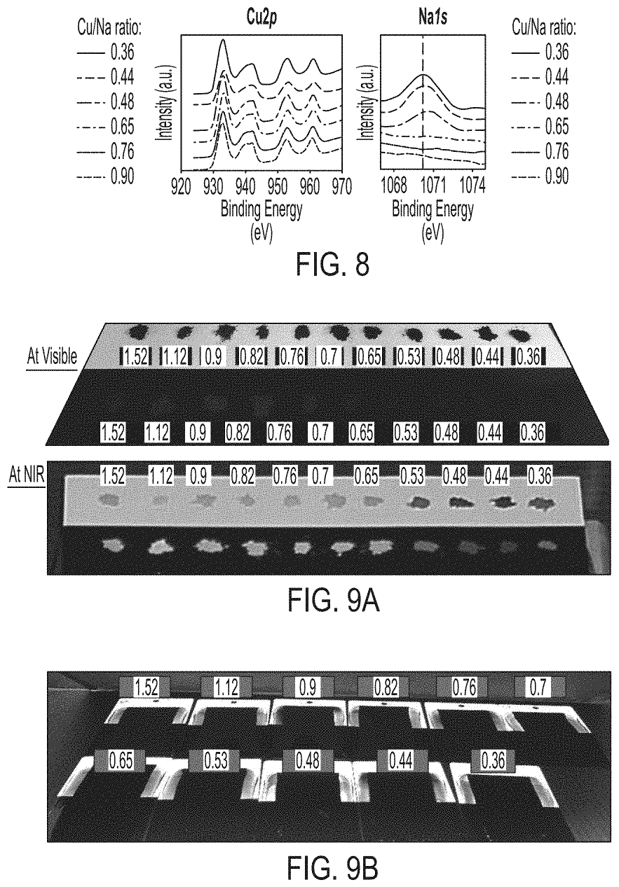

Further XPS measurements reveal that external impurity sodium ions were found in the extracted precipitates where a Cu/Na molar ratio less than 0.65 was used, as shown in FIG. 8. Due to the difference in the size radius of Na⁺ (1.02 Å) and Cu′(0.73 Å) and in the valence charges, the presence of external Na⁺ impurity may affect the growth process of crystals, and raise the surface energy, leading to a dissimilar, irregular morphology as observed in FIG. 7. It can also be seen that the crystallite size decreases with the presence of small amount of Na⁺ as shown in Table 1 above. Hence, a decrease in Cu/Na molar ratio during the synthesis leads to the presence of Na⁺ in the CuCO₃.Cu(OH)₂ precipitate even after the washing and filtration.

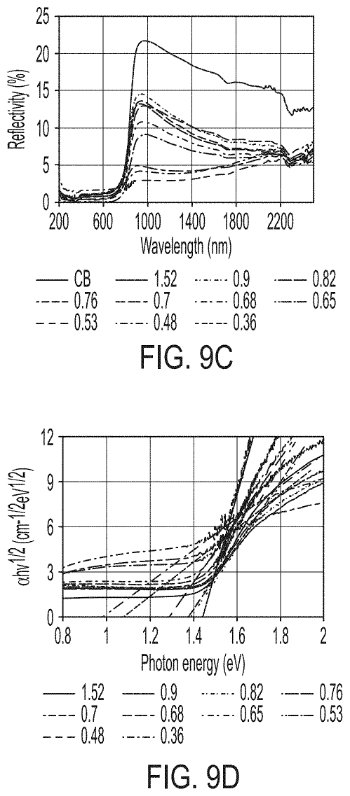

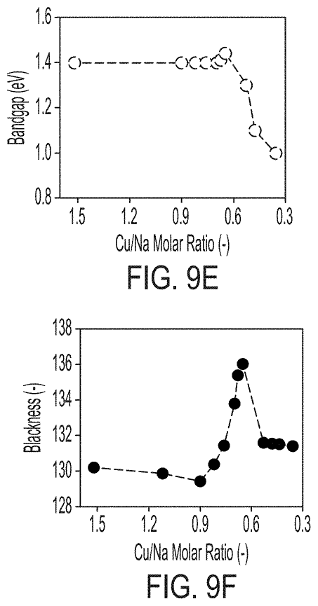

FIG. 9A shows photographic image of the CuO nanoparticles with varying Cu/Na molar ratios over black and white backgrounds in the same order. As shown on the black background, the visual blackness of powders increases with decreasing Cu/Na molar ratio until about 0.7, and then ineligible change in the blackness is observed with further decrease in the Cu/Na molar ratio. However, the photo taken using near-IR camera indicates near-IR and LiDAR reflectivity greatly reduces if Cu/Na molar ratio reduces to less than 0.65, which implies the adverse effect of the Na⁺ impurity onto the crystal structures and the near-IR and LiDAR reflectivity. The painted panel with incorporated CuO nanoparticles is shown in FIG. 9B and the level of blackness was confirmed to be the same irrespective of background color of substrate.

The diffuse reflectance spectra of these paint panels are presented in FIG. 9C (where “CB” denotes carbon black) and the corresponding indirect bandgap Tau plots based on Kubelka-Munk function are shown in FIG. 9D, the resultant bandgap values and blackness data are presented in FIG. 9E and FIG. 9F, respectively. Similar to what was identified in the powder samples, with decreased Cu/Na ratio, a red-shift of the fundamental reflection edge in the prepared CuO paint samples were observed as shown in FIG. 9D. The indirect bang-gap energy of the CuO painted samples of different Cu/Na ratios, show a significant reduction from 1.4 eV to 1.3 eV at a Cu/Na molar ratio around 0.65 as shown in FIG. 9D and FIG. 9E. The blackness My of the panels increases by decreasing Cu/Na molar ratio from no greater than 130 at ratios between 1.52 to 0.76 to no less than 134 when the Cu/Na molar ratio is between 0.7 to 0.65. Further decrease in the Cu/Na molar ratio leads to a decrease in the blackness as shown in FIG. 9D as evidence from the brownish edges shown in the painted samples as shown in FIG. 9B. The results indicate the impact of Cu/Na ratios and the impurity onto the nucleation process, the formation of extracted precipitates, crystallite sizes and agglomerate morphologies. Both blackness measurement and bandgap estimation from the reflectance measurement utilizing Kubelka-Munk analysis conclude that, in embodiments, a Cu/Na ratio between 0.65-0.70 provides both pitch blackness and adequate near-IR and LiDAR reflectivity.

Accordingly, in embodiments, the Cu/Na molar ratio used in precipitates to formulate CuO crystallites, is greater than or equal to 0.3 and less than 1.6, such as greater than or equal to 0.4 and less than 1.6, greater than or equal to 0.5 and less than 1.6, greater than or equal to 0.6 and less than 1.6, greater than or equal to 0.7 and less than 1.6, greater than or equal to 0.8 and less than 1.6, greater than or equal to 0.9 and less than 1.6, greater than or equal to 1.0 and less than 1.6, greater than or equal to 1.1 and less than 1.6, greater than or equal to 1.2 and less than 1.6, greater than or equal to 1.3 and less than 1.6, greater than or equal to 1.4 and less than 1.6, greater than or equal to 1.5 and less than 1.6, greater than or equal to 0.3 and less than 1.5, greater than or equal to 0.4 and less than 1.5, greater than or equal to 0.5 and less than 1.5, greater than or equal to 0.6 and less than 1.5, greater than or equal to 0.7 and less than 1.5, greater than or equal to 0.8 and less than 1.5, greater than or equal to 0.9 and less than 1.5, greater than or equal to 1.0 and less than 1.5, greater than or equal to 1.1 and less than 1.5, greater than or equal to 1.2 and less than 1.5, greater than or equal to 1.3 and less than 1.5, greater than or equal to 1.4 and less than 1.5, greater than or equal to 0.3 and less than 1.4, greater than or equal to 0.4 and less than 1.4, greater than or equal to 0.5 and less than 1.4, greater than or equal to 0.6 and less than 1.4, greater than or equal to 0.7 and less than 1.4, greater than or equal to 0.8 and less than 1.4, greater than or equal to 0.9 and less than 1.4, greater than or equal to 1.0 and less than 1.4, greater than or equal to 1.1 and less than 1.4, greater than or equal to 1.2 and less than 1.4, greater than or equal to 1.3 and less than 1.4, greater than or equal to 0.3 and less than 1.3, greater than or equal to 0.4 and less than 1.3, greater than or equal to 0.5 and less than 1.3, greater than or equal to 0.6 and less than 1.3, greater than or equal to 0.7 and less than 1.3, greater than or equal to 0.8 and less than 1.3, greater than or equal to 0.9 and less than 1.3, greater than or equal to 1.0 and less than 1.3, greater than or equal to 1.1 and less than 1.3, greater than or equal to 1.2 and less than 1.3, greater than or equal to 0.3 and less than 1.2, greater than or equal to 0.4 and less than 1.2, greater than or equal to 0.5 and less than 1.2, greater than or equal to 0.6 and less than 1.2, greater than or equal to 0.7 and less than 1.2, greater than or equal to 0.8 and less than 1.2, greater than or equal to 0.9 and less than 1.2, greater than or equal to 1.0 and less than 1.2, greater than or equal to 1.1 and less than 1.2, greater than or equal to 0.3 and less than 1.1, greater than or equal to 0.4 and less than 1.1, greater than or equal to 0.5 and less than 1.1, greater than or equal to 0.6 and less than 1.1, greater than or equal to 0.7 and less than 1.1, greater than or equal to 0.8 and less than 1.1, greater than or equal to 0.9 and less than 1.1, greater than or equal to 1.0 and less than 1.1, greater than or equal to 0.3 and less than 1.0, greater than or equal to 0.4 and less than 1.0, greater than or equal to 0.5 and less than 1.0, greater than or equal to 0.6 and less than 1.0, greater than or equal to 0.7 and less than 1.0, greater than or equal to 0.8 and less than 1.0, greater than or equal to 0.9 and less than 1.0, greater than or equal to 0.3 and less than 0.9, greater than or equal to 0.4 and less than 0.9, greater than or equal to 0.5 and less than 0.9, greater than or equal to 0.6 and less than 0.9, greater than or equal to 0.7 and less than 0.9, greater than or equal to 0.8 and less than 0.9, greater than or equal to 0.3 and less than 0.8, greater than or equal to 0.4 and less than 0.8, greater than or equal to 0.5 and less than 0.8, greater than or equal to 0.6 and less than 0.8, greater than or equal to 0.7 and less than 0.8, greater than or equal to 0.3 and less than 0.7, greater than or equal to 0.4 and less than 0.7, greater than or equal to 0.5 and less than 0.7, greater than or equal to 0.6 and less than 0.7, greater than or equal to 0.3 and less than 0.6, greater than or equal to 0.4 and less than 0.6, greater than or equal to 0.5 and less than 0.6, greater than or equal to 0.3 and less than 0.5, greater than or equal to 0.4 and less than 0.5, or greater than or equal to 0.3 and less than 0.4.

In some embodiments, and as discussed in more detail below, ammonium carbonate ((NH₄)₂CO₃) is used to form the CuO crystallites in place of sodium-containing composition (such as NaOH and NaCO₃). In such embodiments, the CO₃/Cu molar ratio is greater than or equal to 0.3 and less than 1.6, such as greater than or equal to 0.4 and less than 1.6, greater than or equal to 0.5 and less than 1.6, greater than or equal to 0.6 and less than 1.6, greater than or equal to 0.7 and less than 1.6, greater than or equal to 0.8 and less than 1.6, greater than or equal to 0.9 and less than 1.6, greater than or equal to 1.0 and less than 1.6, greater than or equal to 1.1 and less than 1.6, greater than or equal to 1.2 and less than 1.6, greater than or equal to 1.3 and less than 1.6, greater than or equal to 1.4 and less than 1.6, greater than or equal to 1.5 and less than 1.6, greater than or equal to 0.3 and less than 1.5, greater than or equal to 0.4 and less than 1.5, greater than or equal to 0.5 and less than 1.5, greater than or equal to 0.6 and less than 1.5, greater than or equal to 0.7 and less than 1.5, greater than or equal to 0.8 and less than 1.5, greater than or equal to 0.9 and less than 1.5, greater than or equal to 1.0 and less than 1.5, greater than or equal to 1.1 and less than 1.5, greater than or equal to 1.2 and less than 1.5, greater than or equal to 1.3 and less than 1.5, greater than or equal to 1.4 and less than 1.5, greater than or equal to 0.3 and less than 1.4, greater than or equal to 0.4 and less than 1.4, greater than or equal to 0.5 and less than 1.4, greater than or equal to 0.6 and less than 1.4, greater than or equal to 0.7 and less than 1.4, greater than or equal to 0.8 and less than 1.4, greater than or equal to 0.9 and less than 1.4, greater than or equal to 1.0 and less than 1.4, greater than or equal to 1.1 and less than 1.4, greater than or equal to 1.2 and less than 1.4, greater than or equal to 1.3 and less than 1.4, greater than or equal to 0.3 and less than 1.3, greater than or equal to 0.4 and less than 1.3, greater than or equal to 0.5 and less than 1.3, greater than or equal to 0.6 and less than 1.3, greater than or equal to 0.7 and less than 1.3, greater than or equal to 0.8 and less than 1.3, greater than or equal to 0.9 and less than 1.3, greater than or equal to 1.0 and less than 1.3, greater than or equal to 1.1 and less than 1.3, greater than or equal to 1.2 and less than 1.3, greater than or equal to 0.3 and less than 1.2, greater than or equal to 0.4 and less than 1.2, greater than or equal to 0.5 and less than 1.2, greater than or equal to 0.6 and less than 1.2, greater than or equal to 0.7 and less than 1.2, greater than or equal to 0.8 and less than 1.2, greater than or equal to 0.9 and less than 1.2, greater than or equal to 1.0 and less than 1.2, greater than or equal to 1.1 and less than 1.2, greater than or equal to 0.3 and less than 1.1, greater than or equal to 0.4 and less than 1.1, greater than or equal to 0.5 and less than 1.1, greater than or equal to 0.6 and less than 1.1, greater than or equal to 0.7 and less than 1.1, greater than or equal to 0.8 and less than 1.1, greater than or equal to 0.9 and less than 1.1, greater than or equal to 1.0 and less than 1.1, greater than or equal to 0.3 and less than 1.0, greater than or equal to 0.4 and less than 1.0, greater than or equal to 0.5 and less than 1.0, greater than or equal to 0.6 and less than 1.0, greater than or equal to 0.7 and less than 1.0, greater than or equal to 0.8 and less than 1.0, greater than or equal to 0.9 and less than 1.0, greater than or equal to 0.3 and less than 0.9, greater than or equal to 0.4 and less than 0.9, greater than or equal to 0.5 and less than 0.9, greater than or equal to 0.6 and less than 0.9, greater than or equal to 0.7 and less than 0.9, greater than or equal to 0.8 and less than 0.9, greater than or equal to 0.3 and less than 0.8, greater than or equal to 0.4 and less than 0.8, greater than or equal to 0.5 and less than 0.8, greater than or equal to 0.6 and less than 0.8, greater than or equal to 0.7 and less than 0.8, greater than or equal to 0.3 and less than 0.7, greater than or equal to 0.4 and less than 0.7, greater than or equal to 0.5 and less than 0.7, greater than or equal to 0.6 and less than 0.7, greater than or equal to 0.3 and less than 0.6, greater than or equal to 0.4 and less than 0.6, greater than or equal to 0.5 and less than 0.6, greater than or equal to 0.3 and less than 0.5, greater than or equal to 0.4 and less than 0.5, or greater than or equal to 0.3 and less than 0.4.

As noted above, a first west chemistry method that can be used, according to embodiments, to form CuO crystallites begins with a solution of copper nitrate (Cu(NO₃)₂) having a concentration from greater than or equal to 0.0001 M and less than or equal to 1 M. To that, sodium hydroxide (NaOH) or sodium carbonate (NaCO₃) at a concentration from greater than or equal to 0.1 M and less than or equal to 1 M is introduced as a precipitating agent. The concentration of the Cu(NO₃)₂ and the concentration of the NaOH or NaCO₃ may be selected to have the Na/Cu molar ratios disclosed above. The Cu(NO₃)₂ and the NaOH or NaCO₃ precipitating agent react to form copper hydroxide (Cu(OH)₂) or copper carbonate (CuCO₃) and sodium nitrate (NaNO₃) precipitates. According to embodiments, the mixture is stored at room temperature over night (such as from greater than or equal to eight to less than or equal to fifteen hours). The Cu(OH)₂ is then dried at a temperature greater than or equal to 100° C. and less than or equal to 140° C. for a duration greater than or equal to 0.5 hours and less than or equal to 5.0 hours.

A second wet chemistry method that can be used, according to embodiments, begins with a solution of copper nitrate (Cu(NO₃)₂) having a concentration greater than or equal to 0.0001 M and less than or equal to 1 M. To that solution, ammonium carbonate ((NH₄)₂CO₃) is introduced as a precipitating agent. In this wet chemistry method, an ammonium-based precipitating agent is used in place of the sodium-based precipitating agents of the first wet chemistry method. The sodium-based precipitates formed by the sodium-based precipitating agents can interfere with reactions and lower the yield of CuO. The Cu(NO₃)₂ and the (NH₄)₂CO₃ precipitating agent react to form copper carbonate (CuCO₃) and ammonium nitrate ((NH₄)₂NO₃) precipitates. According to embodiments, the mixture may be stored at room temperature (such as from greater than or equal to 20° C. and less than or equal to 25° C.) overnight (such as greater than or equal to eight hours and less than or equal to fifteen hours). The CuCO₃ is then dried at a temperature greater than or equal to 100° C. and less than or equal to 140° C. for a duration greater than or equal to 0.5 hours and less than or equal to 5.0 hours.

The dried Cu(OH)₂ or CuCO₃ obtained from the first wet chemistry method and the second wet chemistry method, respectively, is, according to embodiments, sintered at a temperature greater than or equal to 200° C. and less than or equal to 400° C. for a duration greater than or equal to 0.5 hours and less than or equal to 5.0 hours.

In one or more embodiments, the dried Cu(OH)₂ or CuCO₃ is sintered at a temperature greater than or equal to 300° C. and less than or equal to 350° C., such as greater than or equal to 310° C. and less than or equal to 350° C., greater than or equal to 320° C. and less than or equal to 350° C., greater than or equal to 330° C. and less than or equal to 350° C., greater than or equal to 340° C. and less than or equal to 350° C., greater than or equal to 300° C. and less than or equal to 340° C., greater than or equal to 310° C. and less than or equal to 340° C., greater than or equal to 320° C. and less than or equal to 340° C., greater than or equal to 330° C. and less than or equal to 340° C., greater than or equal to 300° C. and less than or equal to 330° C., greater than or equal to 310° C. and less than or equal to 330° C., greater than or equal to 320° C. and less than or equal to 330° C., greater than or equal to 300° C. and less than or equal to 320° C., greater than or equal to 310° C. and less than or equal to 320° C., or greater than or equal to 300° C. and less than or equal to 310° C.

According to embodiments, the dried Cu(OH)₂ or CuCO₃ is sintered for a duration of greater than or equal to 1.0 hours and less than or equal to 5.0 hours, such as greater than or equal to 1.5 hours and less than or equal to 5.0 hours, greater than or equal to 2.0 hours and less than or equal to 5.0 hours, greater than or equal to 2.5 hours and less than or equal to 5.0 hours, greater than or equal to 3.0 hours and less than or equal to 5.0 hours, greater than or equal to 3.5 hours and less than or equal to 5.0 hours, greater than or equal to 4.0 hours and less than or equal to 5.0 hours, greater than or equal to 4.5 hours and less than or equal to 5.0 hours, greater than or equal to 0.5 hours and less than or equal to 4.5 hours, greater than or equal to 1.0 hours and less than or equal to 4.5 hours, greater than or equal to 1.5 hours and less than or equal to 4.5 hours, greater than or equal to 2.0 hours and less than or equal to 4.5 hours, greater than or equal to 2.5 hours and less than or equal to 4.5 hours, greater than or equal to 3.0 hours and less than or equal to 4.5 hours, greater than or equal to 3.5 hours and less than or equal to 4.5 hours, greater than or equal to 4.0 hours and less than or equal to 4.5 hours, greater than or equal to 0.5 hours and less than or equal to 4.0 hours, greater than or equal to 1.0 hours and less than or equal to 4.0 hours, greater than or equal to 1.5 hours and less than or equal to 4.0 hours, greater than or equal to 2.0 hours and less than or equal to 4.0 hours, greater than or equal to 2.5 hours and less than or equal to 4.0 hours, greater than or equal to 3.0 hours and less than or equal to 4.0 hours, greater than or equal to 3.5 hours and less than or equal to 4.0 hours, greater than or equal to 0.5 hours and less than or equal to 3.5 hours, greater than or equal to 1.0 hours and less than or equal to 3.5 hours, greater than or equal to 1.5 hours and less than or equal to 3.5 hours, greater than or equal to 2.0 hours and less than or equal to 3.5 hours, greater than or equal to 2.5 hours and less than or equal to 3.5 hours, greater than or equal to 3.0 hours and less than or equal to 3.5 hours, greater than or equal to 0.5 hours and less than or equal to 3.0 hours, greater than or equal to 1.0 hours and less than or equal to 3.0 hours, greater than or equal to 1.5 hours and less than or equal to 3.0 hours, greater than or equal to 2.0 hours and less than or equal to 3.0 hours, greater than or equal to 2.5 hours and less than or equal to 3.0 hours, greater than or equal to 0.5 hours and less than or equal to 2.5 hours, greater than or equal to 1.0 hours and less than or equal to 2.5 hours, greater than or equal to 1.5 hours and less than or equal to 2.5 hours, greater than or equal to 2.0 hours and less than or equal to 2.5 hours, greater than or equal to 0.5 hours and less than or equal to 2.0 hours, greater than or equal to 1.0 hours and less than or equal to 2.0 hours, greater than or equal to 1.5 hours and less than or equal to 2.0 hours, greater than or equal to 0.5 hours and less than or equal to 1.5 hours, greater than or equal to 1.0 hours and less than or equal to 1.5 hours, greater than or equal to 0.5 hours and less than or equal to 1.0 hours.

Embodiments of a system having copper oxide crystallites will now be described. According to embodiments, the system having copper oxide crystallites may be a paint layer with a plurality of copper oxide crystallites in a carrier. According to embodiments disclosed and described herein, the carrier may be a binder. Non-limiting examples of binders including enamel paint binders, urethane paint binders, and combination enamel-urethane paint binders. The system having copper oxide crystallites appears as a dark color to an observer viewing the system having copper oxide crystallites and reflects electromagnetic radiation in the near-IR and LiDAR spectrum, such as, for example, electromagnetic radiation with a wavelength from greater than about 750 nm to 1550 nm. That is, the near-IR and LiDAR reflecting system having copper oxide crystallites, when exposed to sunlight and viewed by an observer, has a color with a lightness in CIELAB color space of less than or equal to 20 and reflects an average of more than 5% of electromagnetic radiation in the near-IR and LiDAR spectrum, such as electromagnetic radiation with a wavelength from greater than about 850 nm to 950 nm. In embodiments, the near-IR and LiDAR reflecting system having copper oxide crystallites when exposed to sunlight reflects an average of less than 3% of electromagnetic radiation in the visible spectrum and has a lightness in CIELAB color space of less than or equal to 15. In such embodiments, the near-IR and LiDAR reflecting system having copper oxide crystallites when exposed to sunlight may have a lightness in CIELAB color space of less than or equal to 10. As used herein, the term “average” refers to an average of ten (10) reflectance values equally distanced apart along a specified reflectance spectrum for a near-IR and LiDAR reflecting dark colored pigment or near-IR and LiDAR reflecting system having copper oxide coated cobalt oxide 300 described herein. Also, the terms “reflects more than” and “reflects less than” as used herein refers to “reflects an average of more than” and “reflects an average or less than”, respectively, unless otherwise stated.

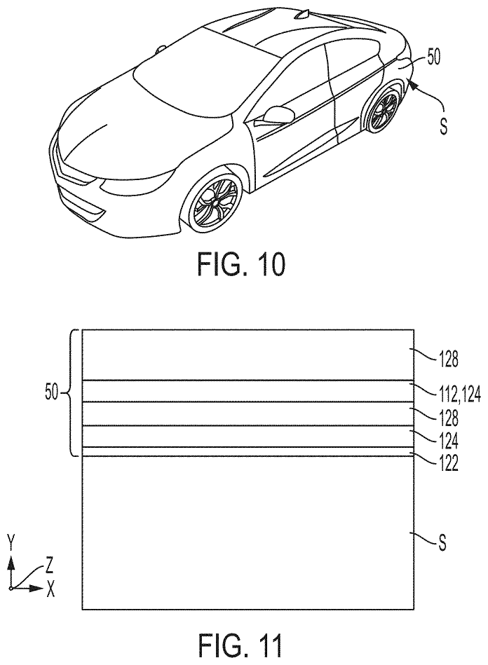

Referring now to FIGS. 10 and 11, embodiments of a vehicle ‘V’ painted with a near-IR and LiDAR reflecting dark colored paint having the copper oxide crystallites disclosed and described herein are depicted. Particularly, FIG. 10 depicts the vehicle V with a side panel ‘S’ coated with a near-IR and LiDAR reflecting dark colored paint 50 comprising the copper oxide crystallites disclosed and described herein, and FIG. 11 depicts a cross section of one of the side panel S with the near-IR and LiDAR reflecting dark colored paint 50. The near-IR and LiDAR reflecting dark colored paint 50 may include a plurality of layers that provide surface protection and a desired color. For example, the near-IR and LiDAR reflecting dark colored paint 50 may include a phosphate layer 122, an electrocoating layer 124, a primer layer 126, a color layer 112 or a color layer 114 (also known as a basecoat or basecoat layer) and a clear coat layer 128. Non-limiting examples of a phosphate layer include a manganese phosphate layer, an iron phosphate layer, a zinc phosphate layer, and combinations thereof. Non-limiting examples of an electrocoating layer include an anodic electrocoating layer and a cathodic electrocoating layer. Non-limiting examples of a primer layer include an epoxy primer layer and a urethane primer layer. Non-limiting examples of a clear coat layer include a urethane clear coat layer and an acrylic lacquer clear coat layer. It should be understood that the near-IR and LiDAR reflecting dark colored paint 50 appears as a dark color to an observer viewing the near-IR and LiDAR reflecting dark paint and reflects electromagnetic radiation in the near-IR and LiDAR spectrum, such as electromagnetic radiation with a wavelength of from greater than about 750 nm to 1550 nm. That is, the near-IR and LiDAR reflecting dark colored paint 50 exposed to sunlight and viewed by an observer has a color with lightness in CIELAB color space of less than or equal to 20 and reflects more than 40% of electromagnetic radiation in the near-IR and LiDAR spectrum, such as electromagnetic radiation with a wavelength from greater than about 750 nm to 1550 nm. In some embodiments, the near-IR and LiDAR reflecting dark colored paint 50 exposed to sunlight reflects an average of less than 10% of electromagnetic radiation in the visible spectrum and has a lightness in CIELAB color space of less than or equal to 15. In such embodiments, the LiDAR reflecting dark colored paint 50 exposed to sunlight may have a lightness in CIELAB color space of less than or equal to 10.

The blackness of a paint system having a clear coat may be lower than the blackness of the pigment itself. Without being bound by any particular theory it is believed that less light scattering from the smooth surface of the clear coat, or the less contrast in refractive index caused by the clear coat results in the lower blackness value. According to embodiments, a near-IR and LiDAR reflecting dark colored paint having the copper oxide crystallites has a blackness greater than or equal to 120 and less than or equal to 140, such as greater than or equal to 122 and less than or equal to 140, greater than or equal to 124 and less than or equal to 140, greater than or equal to 126 and less than or equal to 140, greater than or equal to 128 and less than or equal to 140, greater than or equal to 130 and less than or equal to 140, greater than or equal to 132 and less than or equal to 140, greater than or equal to 134 and less than or equal to 140, greater than or equal to 136 and less than or equal to 140, greater than or equal to 138 and less than or equal to 140, greater than or equal to 120 and less than or equal to 138, greater than or equal to 122 and less than or equal to 138, greater than or equal to 124 and less than or equal to 138, greater than or equal to 126 and less than or equal to 138, greater than or equal to 128 and less than or equal to 138, greater than or equal to 130 and less than or equal to 138, greater than or equal to 132 and less than or equal to 138, greater than or equal to 134 and less than or equal to 138, greater than or equal to 136 and less than or equal to 138, greater than or equal to 120 and less than or equal to 136, greater than or equal to 122 and less than or equal to 136, greater than or equal to 124 and less than or equal to 136, greater than or equal to 126 and less than or equal to 136, greater than or equal to 128 and less than or equal to 136, greater than or equal to 130 and less than or equal to 136, greater than or equal to 132 and less than or equal to 136, greater than or equal to 134 and less than or equal to 136, greater than or equal to 120 and less than or equal to 134, greater than or equal to 122 and less than or equal to 134, greater than or equal to 124 and less than or equal to 134, greater than or equal to 126 and less than or equal to 134, greater than or equal to 128 and less than or equal to 134, greater than or equal to 130 and less than or equal to 134, greater than or equal to 132 and less than or equal to 134, greater than or equal to 120 and less than or equal to 132, greater than or equal to 122 and less than or equal to 132, greater than or equal to 124 and less than or equal to 132, greater than or equal to 126 and less than or equal to 132, greater than or equal to 128 and less than or equal to 132, greater than or equal to 130 and less than or equal to 132, greater than or equal to 120 and less than or equal to 130, greater than or equal to 122 and less than or equal to 130, greater than or equal to 124 and less than or equal to 130, greater than or equal to 126 and less than or equal to 130, greater than or equal to 128 and less than or equal to 130, greater than or equal to 120 and less than or equal to 128, greater than or equal to 122 and less than or equal to 128, greater than or equal to 124 and less than or equal to 128, greater than or equal to 126 and less than or equal to 128, greater than or equal to 120 and less than or equal to 126, greater than or equal to 122 and less than or equal to 126, greater than or equal to 124 and less than or equal to 126, greater than or equal to 120 and less than or equal to 124, greater than or equal to 122 and less than or equal to 124, or greater than or equal to 120 and less than or equal to 122.

As noted above near-IR and LiDAR reflecting he copper oxide crystallites according to embodiments disclosed and described herein may be used in paint to provide near-IR and LiDAR reflecting dark colored articles that can be detected with systems that detect near-IR or LiDAR electromagnetic radiation, such as electromagnetic radiation with a wavelength from greater than about 750 nm to 1550 nm. That is, articles desired to be detected by near-IR and LiDAR detection systems such as automobiles, motorcycles, bicycles, and the like, may be painted with a near-IR and LiDAR reflecting dark colored paint described herein and thereby provide a dark colored article with a desired dark color and yet be detectable by system that detects electromagnetic radiation in the near-IR and LiDAR spectrum, such as electromagnetic radiation with a wavelength from greater than about 750 nm to 1550 nm.

As would be understood from the foregoing, copper oxide crystallites according to embodiments disclosed and described herein offer an effective solution to replace traditional carbon black pigments in the future autonomous environment. Copper oxide crystallites show superior blackness in the visible region while keeping infrared reflectivity.

### EXAMPLES

Embodiments will be further clarified by the following examples.

### Example 1—Synthesis

Analytic grade (AR) copper (II) nitrate Cu(NO₃)₂, sodium hydroxide (NaOH) and sodium carbonate Na₂CO₃ obtained from Sigma Aldrich, and deionized water were used without any further purification.

CuO nanoparticles were synthesized by a coprecipitation method using Na₂CO₃ or NaOH as precipitating agents. The required amount of Cu(NO₃)₂ was dissolved in 300 ml distilled water. Then, known concentration of Na₂CO₃ or NaOH solution was added dropwise to the Cu(NO₃)₂ solution at room temperature with vigorous stirring. Then the solution was stirred for 3 hours and aged overnight before filtration. After the overnight aging, the precipitate was filtered and washed with 1000 ml of distilled water. The solid products are then dried at 120° C. overnight, following by sintering from 300° C. to 600° C. for 3 hours with 5° C./min ramp rate.

Further, control experiments were carried out following the same procedure to analyze the effect of base types, Cu/Na molar ratio and sintering process on the crystal structure and morphology of CuO nanoparticles. Finally, a comparison of morphology and optical properties of these different systems to our representative sample, N-CuO-A, is presented. Crystallographic information of CuO nanoparticles were investigated using powder X-ray diffraction (XRD, Japan, Rigaku Miniflex 600) with Cu Kα radiation (λ=0.1541 nm). The average crystallite size t of prepared particles was estimated from the measured width of their XRD diffraction curves by using Scherrer's formula.

$$τ = \frac{k λ}{β cos θ} \qquad ( 7 )$$

Here k is a dimensionless shape factor with a value close to unity. λ represents the wavelength of the X-ray radiation, β is the line broadening at half the maximum intensity (FWHM) and θ is the Bragg's angle. The morphology and structure were determined by scanning electron microscope (SEM, Japan, Jeol JSM-7800FLV) equipped with energy-dispersive spectroscopy (EDS) and high-resolution transmission electron microscopy (HR-TEM). TEM and small area electron diffraction (SAED) were performed by EAG Laboratory. Samples were prepared by dispersing the powder in alcohol by ultrasonic treatment, positioning a drop onto a copper grid support, and then drying in the air.

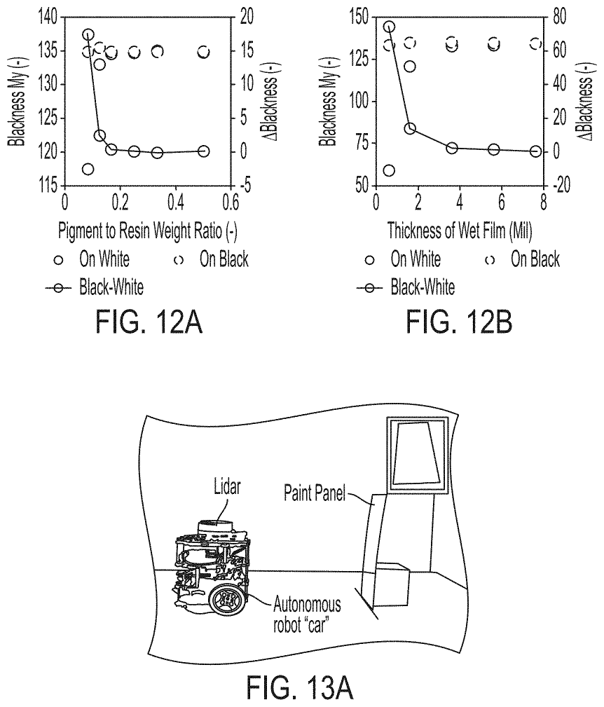

For painted samples, if not specified, the CuO crystallites were mixed with polyurethane resin at a powder/resin ratio of 1:4, and then applied via a doctor blade with wet film-thickness of 200 μm (or 8 mil) onto the steel panel with precoated half-black (reflectance—1% maximum) and half-white (reflectance—78% minimum) surfaces. Then a transparent clear coat of 60 μm in dry film thickness was applied over the samples resembling automotive paint system. The conditions above were enough to achieve consistent level of blackness irrespective of background color of substrate as shown in FIG. 12A and FIG. 12B. Therefore, only intrinsic properties of particle containing film were measured. With further increment of particle concentration in the resin system we have not observed any impact of the degree of blackness.

Optical properties of painted panels were studied by UV/Vis/NIR spectrophotometers (USA Agilent Cary 7000). The bandgap calculation is based on the Kubelka-Munk function F(R_{∞}) which is related to the diffuse reflectance, R_{∞}, of the sample by the relation below:

F(R_{∞})=(1−R_{∞})²/2R_{∞} (8)

Here, R_{∞} is the absolute value of reflectance and F(R_{∞}) is equivalent to the absorption coefficient. The indirect bandgap of samples was estimated by plotting (F(R_∞) fiv)^{0.5} versus energy. The linear part of the curve was extrapolated to (F(R_∞))⁰⁵=0 to obtain the indirect bandgap energy.

The degree of blackness M_{y} of painted samples was evaluated by X-Rite Ci7600 benchtop spectrophotometer (USA, X-Rite) that directly related to the reference provided by the instrument.

M_{Y}=100 log(Yₙ/Y) (9)

Where Yₙ=100.000 is one of the CIE White Point values for D65/10 conditions. Y are one of the CIE tristimulus values for the sample being measured.

X-ray Photoelectron Spectroscopy (XPS, USA PHI 5000 Versaprobe II) measurement was carried out using the Al Kα line as the excitation source. Charging of the catalyst samples was corrected by setting the binding energy of the adventitious carbon (C1s) to 284.6 eV. The XPS analysis was performed at ambient temperature, and pressures were typically on the order of 10⁷ Torr. Before the analysis, the samples were outgassed under vacuum for 30 min. The measurement of Thermo-Gravimetric Analysis (TGA, USA Thermal Science TGA Q500) was conducted in air with test range from 25° C.-600° C. and heating rate was 5° C.·min⁻¹. The surface area of CuO nanoparticles was measured by the single point Brunauer-Emmett-Teller (BET) method through nitrogen adsorption/desorption analysis (3 flex chemi, USA Micromeritics). Before the analyses, the samples were outgassed at 300° C. under vacuum (5×10⁻³ Torr) for two hours.

### Example 2—LiDAR Reflection Performance

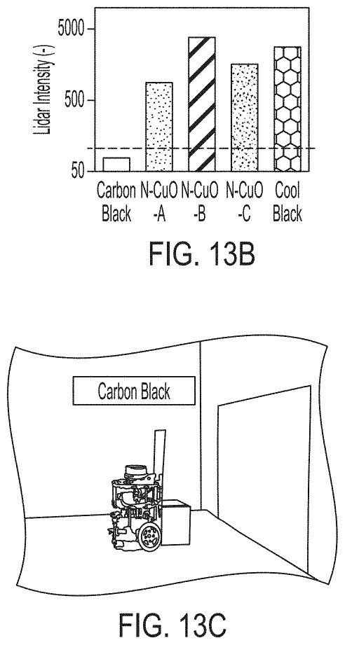

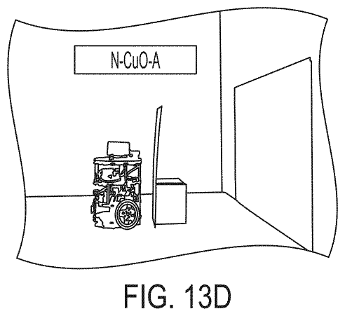

To validate the LiDAR reflective performance of N-CuO-A synthesized as disclosed herein, a robot car (Model TurtleBot 3 Burger) equipped with a 2D laser scanner at 905 nm was used to mimic an autonomous driving car. The laser scanner is capable of sensing 360 degrees that collects a set of data around the robot to use for SLAM (Simultaneous Localization and Mapping) and Navigation, as well as performing stop when obstacle is detected. FIG. 13A shows the set up where a paint panel was placed in front of autonomous robot car each time and inset figure shows the prepared N-CuO-A painted panel which appears identical to carbon black paint. The intensity of LiDAR sensor reflected by the panel and recorded on the screen, if the distance and angle are fixed, are solely proportional to the reflectivity intensity of the panels at 905 nm. The detected LiDAR intensity values on the sensor were recorded via Bluetooth in FIG. 13B when the tested panels were placed in front of the robot car at a fixed distance of 6 inches and a fixed angle (8°). It clearly reveals that N-CuO-A painted panels have significantly higher LiDAR intensity (nearly 1500%) than that made of carbon black panels. Accordingly, the LiDAR reflectivity from the N-CuO-A paint sample is enough for the robot car to detect and to perform an automatic “stop”, as shown in FIG. 13D, while it would “bump” onto the carbon black panel due to near full absorption in near-IR wavelengths as shown in FIG. 13C.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A copper oxide crystallite comprising:
an average particle size that is greater than or equal to 5 nm and less than or equal to 15 nm;
a ratio of (−111)/(111) greater than or equal to 0.5 and less than or equal to 1.5; and
a blackness My greater than or equal to 130 and less than or equal to 170,
wherein the copper oxide crystallite has:
a reflectivity in the visible spectrum of electromagnetic radiation that is less than or equal to 10.0%, and
a reflectivity in the near-IR and LiDAR spectrum of electromagnetic radiation that is greater than or equal to 10%.

2. The copper oxide crystallite of claim 1, wherein the copper oxide crystallite has a reflectivity of electromagnetic radiation in the visible spectrum of electromagnetic radiation that is less than or equal to 5%.

3. The copper oxide crystallite of claim 1, wherein the copper oxide crystallite has a reflectivity for electromagnetic radiation in the near-IR and LiDAR spectrum of electromagnetic radiation that is greater than or equal to 20%.

4. The copper oxide crystallite of claim 1, wherein the ratio of (−111)/(111) is greater than or equal to 0.9 and less than or equal to 1.1.

5. The copper oxide crystallite of claim 1, wherein the average particle size is greater than or equal to 8 nm and less than or equal to 12 nm.

6. The copper oxide crystallite of claim 1, wherein the blackness My is greater than or equal to 150 and less than or equal to 170.

7. The copper oxide crystallite of claim 1, wherein
the average particle size is greater than or equal to 8 nm and less than or equal to 12 nm,
the ratio of (−111)/(111) is greater than or equal to 0.9 and less than or equal to 1.1,
the blackness My is greater than or equal to 150 and less than or equal to 170,
the reflectivity in the visible spectrum of electromagnetic radiation is less than or equal to 5.0%, and
the reflectivity in the near-IR and LiDAR spectrum of electromagnetic radiation is greater than or equal to 20%.

8. A paint comprising:
a paint binder;
a plurality of copper oxide crystallites according to claim 1, wherein
the paint has a color with a lightness in CIELAB color space less than or equal to 40.

9. A vehicle comprising a body panel coated in the paint of claim 8.

10. A method for forming a copper oxide crystallites comprising:
combining a precipitating agent with a solution comprising copper nitrate to form a precipitate;
drying the precipitate, thereby obtaining dried precipitate; and
sintering the dried precipitate to form copper oxide crystallites having an average particle size that is greater than or equal to 5 nm and less than or equal to 15 nm, wherein
the precipitating agent is selected from the group consisting of sodium hydroxide, sodium carbonate, or ammonium carbonate.

11. The method of claim 10, wherein the precipitating agent is selected from the group consisting of sodium hydroxide and sodium carbonate.

12. The method of claim 11, wherein a Cu/Na molar ratio is greater than or equal to 0.3 and less than 1.6.

13. The method of claim 11, wherein a Cu/Na molar ratio is greater than or equal to 0.5 and less than 1.0.

14. The method of claim 11, wherein a Cu/Na molar ratio is greater than or equal to 0.65 and less than 0.76.

15. The method of claim 10, wherein drying the copper oxide crystallites comprises drying at a temperature greater than or equal to 100° C. and less than or equal to 140° C. for a duration greater than or equal to 0.5 hours and less than or equal to 5.0 hours.

16. The method of claim 10, wherein sintering the copper oxide crystallites comprises sintering at a temperature greater than or equal to 200° C. and less than or equal to 300° C.

17. The method of claim 10, wherein sintering the copper oxide crystallites comprises sintering at a temperature greater than or equal to 250° C. and less than or equal to 300° C.

18. The method of claim 16, wherein sintering occurs for a duration greater than or equal to 0.5 hours and less than or equal to 5.0 hours.

19. The method of claim 10, wherein the precipitating agent is ammonium carbonate.

20. The method of claim 10, wherein the average particle size is greater than or equal to 8 nm and less than or equal to 12 nm.
